(19) United States
(12) Patent Application Publication
(10) Pub. No.: US 2009/0290169 A1
(43) Pub. Date: Nov. 26, 2009

(54) IMAGE PROCESSING APPARATUS AND METHOD OF CONTROLLING THE SAME

(75) Inventor: Kazufumi Kobashi, Tokyo (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/471,687

(22) Filed: May 26, 2009

(30) Foreign Application Priority Data
May 26, 2008 (JP) 2008-137228

(51) Int. Cl. G06K 15/00; G06F 15/00; G06K 15/02; B42D 1/00

(52) U.S. Cl. 358/1.2; 358/1.18; 281/27; 715/243

(57) ABSTRACT

To facilitate page layout suitable for a bookbinding method, an image processing apparatus includes a determination unit which, when booklet printing of forming a book by folding a plurality of sheets is set, determines, based on the shape of image data to be laid out on the sheet, whether to lay out the image data on a spread of the book, a decision unit which decides, based on an object in the image data determined to be laid out on the spread of the book, whether to divide and lay out the image data, and a layout unit which divides the image data decided by the decision unit to be divided, and lays out each of the divided image data on the sheet of the spread.

### BACKGROUND OF THE INVENTION

1. Field of the Invention

The present invention relates to a technique of laying out input images on pages in a binding process.

2. Description of the Related Art

In the printing industry or copying industry, POD (Print On Demand) using a high-speed digital multifunction peripheral is becoming widespread as a tool of wide-variety, small-batch printing. Offices are introducing POD for the purpose of in-house manufacturing of printed products such as catalogues. In commercial printing, various kinds of booklet printing such as case handbook, case binding, and flat stitching are done to create high-quality products. To obtain products at low cost, a plurality of document pages are laid out on one sheet, and the sheet is cut after printing. Digital multifunction peripherals that are recently gaining more sophisticated functions allow an in-line bookbinding device to implement bookbinding such as case binding as in commercial printing.

High-quality in-house booklet printing is even being introduced into the central printing room of offices. There is also a standard job ticket format called JDF (Job Definition Format) in the printing industry or a system that cooperates with an MIS (Management Information System). This accelerates building of workflows including print cost control and progress control. These workflows also implement near-line bookbinding which connects a digital multifunction peripheral to a bookbinding machine used in commercial printing via a network to perform whole processing from printing to bookbinding based on one job. Even for special bookbinding (e.g., quarto+case binding, or flat stitching) that has been implemented so far only by an expensive bookbinding machine, use of the near-line bookbinding enables all processes from document reception to bookbinding by one job.

It is common practice to convert received document data into data independent of the application that has created the document data, and output it to a printing apparatus together with manipulation instructions such as page layout/stapling and punch hole. Even a system for performing these prepress processes is gaining advanced functions such as a JDF job generation function and a variety of page layout functions to cope with the above-described workflows.

Japanese Patent Laid-Open No. 2006-205642 discloses a technique about spread page layout in booklet printing. It is particularly related to a technique of adjusting the page sequence in saddle-stitched booklet printing so that a spread document is laid out, without being divided, on the innermost pages of saddle-stitched sheets.

In the above-described technique, since a spread page is laid out on the innermost pages of saddle-stitched sheets, the spread page can be laid out without being divided. However, it is difficult to output the pages in an appropriate order. It is also necessary to consider a bookbinding method to be used, as will be described below, and this requires an expert knowledge of page layout and booklet printing.

FIG. 14 is a view showing pagination of sheets (page layout on sheets) in various bookbinding methods. Reference numeral 1400a represents pagination of saddle stitching; 1400b, pagination of flat stitching; and 1400c, pagination of a quarto. FIG. 15 is a view showing the concepts of various bookbinding methods. Reference numeral 1500a represents a conceptual illustration of saddle stitching; 1500b, a conceptual illustration of flat stitching; and 1500c, a conceptual illustration of case binding.

Reference numeral 1401 denotes a sheet (board); 1402, a page; 1403, a page number. A spread page makes sense on two, left and right (upper and lower) pages of an opened book. For this reason, there are pages that allow spread layout and pages that do not occur upon pagination.

For example, in the saddle stitching 1400a, outermost and innermost pages 1405 of saddle-stitched sheets are usable for spread layout. Pages 1404 with numbers 2-3, 4-5, 8-9, or 10-11 are also usable for spread layout, although they are laid out on different sheets. To the contrary, pages with numbers 1-2, 3-4, 5-6, 7-8, 9-10, or 11-12 do not allow spread layout because they are printed on obverse and reverse sides of one sheet although the numbers are consecutive. The pages 1404 with numbers 2-3, 4-5, 8-9, or 10-11 are laid out on different sheets, and therefore, spread document data needs to be divided. On the other hand, the pages with numbers 1-12 or 6-7 are laid out on a single sheet, and spread document data need not be divided.

Reference numeral 1400d indicates an example of document data division. Document data 1406 is data before division. When dividing document data for a spread page, the data is fundamentally divided in the middle, and two divided pages 1407 and 1408 are laid out. In the flat stitching 1400b, the pages 1404 with numbers 4-5 or 8-9 allow spread layout by dividing spread document data. The pages 1405 with numbers 2-3, 6-7, or 10-11 enable spread layout without dividing spread document data. In the quarto 1400c, pages with numbers 4-5 allow spread layout without dividing spread document data. As described above, page layout of spread document data needs to be performed in consideration of pagination in a bookbinding method.

Reference numeral 1501 denotes a sheet; 1502, a staple; and 1503, a gutter property in the saddle stitching 1500a. “Gutter” is a term indicating the inner (bound) portion of a book. The gutter property changes depending on the bookbinding method. In saddle stitching, the gutter rarely generates a dead space by binding and becomes invisible, as represented by 1503. “Gutter dead space” is a term indicating a phenomenon that gutter-side parts of sheets of an opened book become invisible because of the binding method (when a book is bound by stapling or gluing) or the thickness of the sheets. A gutter dead space is basically not generated in pages that allow laying out spread document data without dividing. For other pages, however, a gutter dead space may be generated to some extent because of the thickness of sheets. Reference numeral 1504 denotes a gutter property in the flat stitching 1500b. In flat stitching, the direction of binding by stapling or the like is parallel to the sheet open direction. Hence, a large gutter dead space is formed. The case binding 1500c has a gutter property different from those of the above-described two bookbinding methods. Reference numeral 1505 denotes a cover of case binding; and 1506, glue to bind the cover and inside sheets. Case binding generally uses gluing to bind sheets. To make glue hold well, the gutter-side parts of sheets are cut away. Cut sheet parts 1507 are removed from the book. To correct the influence of the above-described gutter dead space, the operator sets a “binding margin” and shifts the print position of document data to be laid out on each page. “Binding margin” indicates a width that becomes invisible due to the influence of folding in binding. This equals the width of the above-described gutter dead space. The cutting width of gutter-side parts in the case binding is called a “milling width”. The operator sets the “milling width” not to cut document data, and shifts the print position of document data to be laid out on each page. That is, in page layout of booklet printing, it is necessary to correct the document laid out on pages in accordance with the gutter property of the bookbinding method.

As described above, page layout of spread document data and gutter-side correction require an expert knowledge of page layout and booklet printing, and are therefore done by a specialist in general. However, such special bookbinding is now possible even in an office environment using a workflow of near-line bookbinding or the like. In this case, an office user executes the prepress processes, but doing page layout suitable for a bookbinding method makes the burden heavy.

The present invention provides facilitating page layout suitable for a bookbinding method. The present invention also provides facilitating spread document data gutter correction processing suitable for a bookbinding method.

### SUMMARY OF THE INVENTION

According to one aspect of the present invention, an image processing apparatus comprises: a determination unit which, when booklet printing of forming a book by folding a plurality of sheets is set, determines, based on a shape of image data to be laid out on the sheet, whether to lay out the image data on a spread of the book; a decision unit which decides, based on an object in the image data determined to be laid out on the spread of the book, whether to divide and lay out the image data; and a layout unit which divides the image data decided by the decision unit to be divided, and lays out each of the divided image data on the sheet of the spread.

According to another aspect of the present invention, a method of controlling an image processing apparatus, comprises the steps of: when booklet printing of forming a book by folding a plurality of sheets is set, determining, based on a shape of image data to be laid out on the sheet, whether to lay out the image data on a spread of the book; deciding, based on an object in the image data determined to be laid out on the spread of the book, whether to divide and lay out the image data; and dividing the image data decided in the deciding step to be divided, and laying out each of the divided image data on the sheet of the spread.

According to the present invention, it is possible to provide a technique of facilitating page layout suitable for a bookbinding method. It is also possible to provide a technique of facilitating spread document data gutter correction processing suitable for a bookbinding method.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the software configuration of a document processing system according to the first embodiment;

FIG. 2 is a block diagram showing the hardware configuration of a computer 100;

FIG. 3 is a view schematically showing examples of a book file format and document data;

FIGS. 4A and 4B are views showing a list of book attributes;

FIG. 5 is a view showing a list of chapter attributes;

FIG. 6 is a view showing a list of page attributes;

FIG. 7 is a flowchart illustrating an operation of causing a bookbinding application 104 to open a book file;

FIG. 8 is a flowchart illustrating a procedure of electronic document import;

FIG. 9 is a flowchart illustrating an operation of causing an electronic document writer 102 to generate an electronic document file;

FIG. 10 is a view showing an example of a UI window which displays a designated book file;

FIG. 11 is a view showing an example of a UI window displayed when a new book file is created;

FIG. 12 is a block diagram showing the arrangement of a server-client type document processing system;

FIG. 13 is block diagram showing the arrangement of a staple control system;

FIG. 14 is a view showing pagination of sheets in various bookbinding methods;

FIG. 15 is a view showing the concepts of various bookbinding methods;

FIG. 16 is a view showing the constituent elements of a bookbinding system according to the first embodiment;

FIG. 17 is a flowchart illustrating overall processing according to the first embodiment;

FIG. 18 is a view showing a sheet configuration information list and its definition;

FIG. 19 is a view showing a UI of the bookbinding application 104;

FIG. 20 is a view showing the sheet configuration information list 1801 added with spread page information 2001;

FIG. 21 is a flowchart of page layout processing;

FIG. 22 is a view showing an example of the sheet configuration information list updated by a process in step S2103;

FIG. 23 is a flowchart of spread page determination processing;

FIG. 24 is a conceptual view of received document data and the layout region of one page after bookbinding;

FIG. 25 is a flowchart of page division determination processing;

FIG. 26 is a view showing the concept of content information analysis processing;

FIG. 27 is a view showing a message dialogue to receive a document data division instruction;

FIG. 28 is a flowchart illustrating division position correction to be performed as page layout correction processing (page division);

FIG. 29 is a view showing the concept of division position correction;

FIG. 30 is a flowchart illustrating variable scaling to be performed as page layout correction processing (page division);

FIG. 31 is a view showing the concept of variable scaling;

FIG. 32 is a view showing a message dialogue to receive a processing designation;

FIG. 33 is a flowchart of page layout correction processing (without page division);

FIG. 34 is a view of the concept of page layout correction processing (without page division);

FIG. 35 is a flowchart of gutter-side correction processing (1);

FIG. 36 is a conceptual view showing the gutter of a flat-stitched book viewed from a side so as to explain the gutter property;

FIG. 37 is a flowchart of gutter-side correction processing (2);

FIG. 38 is a conceptual view showing the gutter of a flat-stitched book viewed from a side so as to explain the gutter property; and

FIG. 39 is a view showing a message dialogue to receive a gutter-side correction processing designation.

### DESCRIPTION OF THE EMBODIMENTS

Preferred embodiments of the present invention will now be described in detail with reference to the accompanying drawings. Note that the following embodiments are not intended to limit the scope of the invention, but are merely examples.

### First Embodiment

A document processing system will be exemplified below as an image processing apparatus according to the first embodiment of the present invention.

<Outline of System>

An outline of the document processing system according to the first embodiment will be described first. The document processing system includes an electronic document writer which converts a data file created by a general application into an electronic document file, and a bookbinding application which provides a function of editing the electronic document file.

<Overview of System Arrangement and Operation>

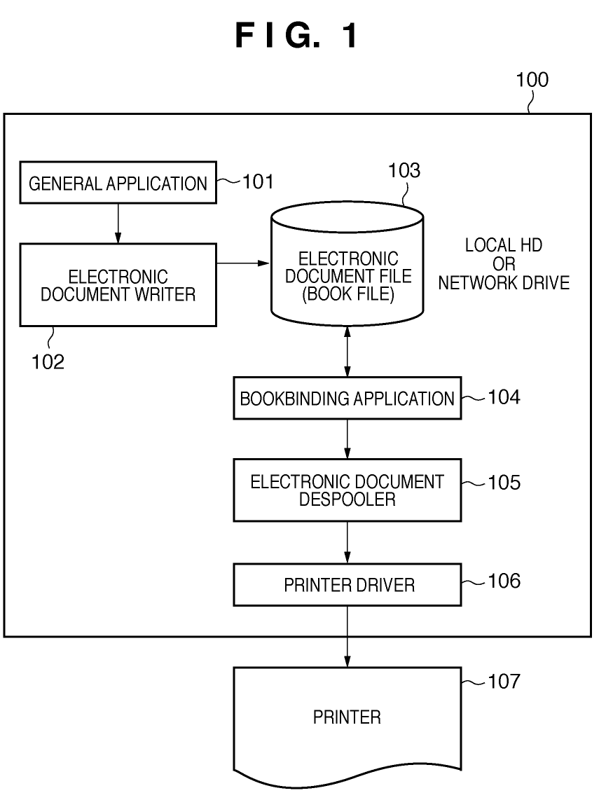

FIG. 1 is a block diagram showing the software configuration of the document processing system according to the first embodiment. The document processing system is implemented by causing a computer (PC) 100 to execute various kinds of application programs.

A general application 101 is an application program which provides functions such as wordprocessing, spreadsheet, photo retouch, draw, and text edit. These applications use a predetermined image output interface which is provided by the operating system (OS) when printing application data such as created document data or image data. More specifically, to print created data, the general application 101 transmits a predetermined OS-dependent output command (called a GDI function) to the output module of the OS that provides the above-described interface. The output module receives the output command, converts it into a format processable by individual output devices such as a printer, and outputs the converted command (called a DDI function). Since the format processable by an output device changes depending on the device type, maker, model, and the like, each device provides a device driver. The OS converts the command, generates print data, and encloses it in a JL (Job Language) using the device driver, thereby generating a print job. When Microsoft Windows is used as the OS, a GDI (Graphic Device Interface) module corresponds to the above-described output module.

An electronic document writer 102 is a software module provided to implement the document processing system and corresponds to the device driver. However, the electronic document writer 102 does not aim at a specific output device, and converts an output command into a data format processable by a bookbinding application 104 or a printer driver 106 (both will be described later). The format (to be referred to as an “electronic document format” hereinafter) after conversion by the electronic document writer 102 is not particularly limited as far as it can express the document of each page using a detailed format. Of practical standard formats, for example, a PDF format of Adobe Systems in the U.S.A. or an SVG format can be adopted as the electronic document format.

To use the electronic document writer 102, the general application 101 designates the electronic document writer 102 as a device driver to be used for output and then executes printing. However, an electronic document file created by the electronic document writer 102 does not have a perfect format as an electronic document file. For this reason, the bookbinding application 104 designates the electronic document writer 102 as a device driver. Application data is converted into an electronic document file under the control of the bookbinding application 104. The bookbinding application 104 completes a new, imperfect electronic document file generated by the electronic document writer 102 as an electronic document file having a format to be described later. If it is necessary to clearly distinguish between a file created by the electronic document writer 102 and an electronic document file whose structure is given by the bookbinding application 104, the former will be referred to as an “electronic document file”, whereas the latter will be referred to as a “book file”. Note that if they need not be especially distinguished from each other, all document files, electronic document files, and book files generated by applications will be referred to as document files (or document data) hereinafter.

The general application 101 designates the electronic document writer 102 as a device driver, and prints target data, thereby storing an electronic document file 103 in a storage medium such as a hard disk. The electronic document file 103 is data having an electronic document format including pages (to be referred to as “document pages” hereinafter) defined by the general application 101 as a unit.

The bookbinding application 104 provides, to the user, functions to read out the electronic document file (or book file) 103 and edit it. However, the bookbinding application 104 provides no function of editing the contents (objects) of each page but a function of editing the structure of a book or a chapter (to be described later). In particular, in the first embodiment, the bookbinding application 104 provides a pagination processing (layout processing) function.

When printing the electronic document file 103 edited by the bookbinding application 104, the bookbinding application 104 activates an electronic document despooler 105. The electronic document despooler 105 is a program module installed in the computer together with the bookbinding application. The electronic document despooler 105 is used to output rendering data to a printer driver when printing a document (book file) used by the bookbinding application. The electronic document despooler 105 reads out a designated book file from the hard disk, generates an output command suitable for the above-described output module of the OS so as to print the pages in a format described in the book file, and outputs the command to the output module (not shown). At this time, the printer driver 106 for a printer 107 to be used as an output device is designated as a device driver. The above-described output module converts the received output command into a device command, and outputs it to the printer driver 106 for the designated printer (image forming apparatus) 107. The printer driver 106 converts the command into a command in, for example, a page description language interpretable by the printer 107. The printer driver 106 transmits the converted command to the printer 107 via a system spooler (not shown). The printer 107 prints an image corresponding to the command on a printing medium such as a sheet.

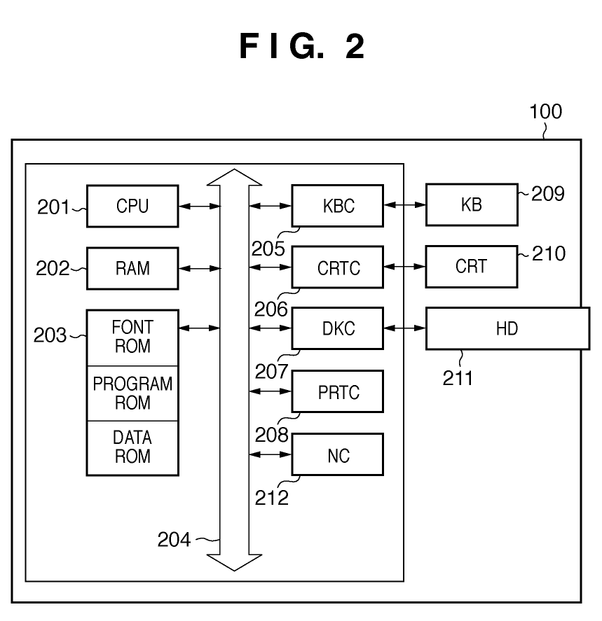

FIG. 2 is a block diagram showing the hardware of the computer 100.

A CPU 201 executes the OS and programs such as the general application and the bookbinding application stored in a ROM 203 or loaded from a hard disk 211 to a RAM 202. The CPU 201 thus implements the functions of the software in FIG. 1 and the procedures of flowcharts to be described later. The RAM 202 functions as the main memory or work area of the CPU 201. A keyboard controller (KBC) 205 controls key inputs from a keyboard 209 or a pointing device (not shown). A CRT controller (CRTC) 206 controls display on a CRT display 210. A disk controller (DKC) 207 controls access to, for example, the hard disk (HD) 211 or a floppy® disk (FD) which stores boot programs, various applications, font data, user files, and edit files to be described later. A PRTC 208 controls signal exchange with the connected printer 107. An NC 212 is connected to the network and controls communication with other devices connected to the network.

<Format of Electronic Document Data>

The data format of a book file will be described before an explanation of details of the bookbinding application 104.

A book file has a three-layered structure which simulates a book of paper media. The upper layer is called “book”, which simulates one book and defines attributes associated with the whole book. The intermediate layer below the upper layer corresponds to chapters in a book, and is also called “chapter” even on electronic document data. It defines the attributes of each chapter. The lower layer is “page” corresponding to respective pages defined by the application program. It defines the attributes of each page. One book may include a plurality of chapters, and one chapter may include a plurality of pages.

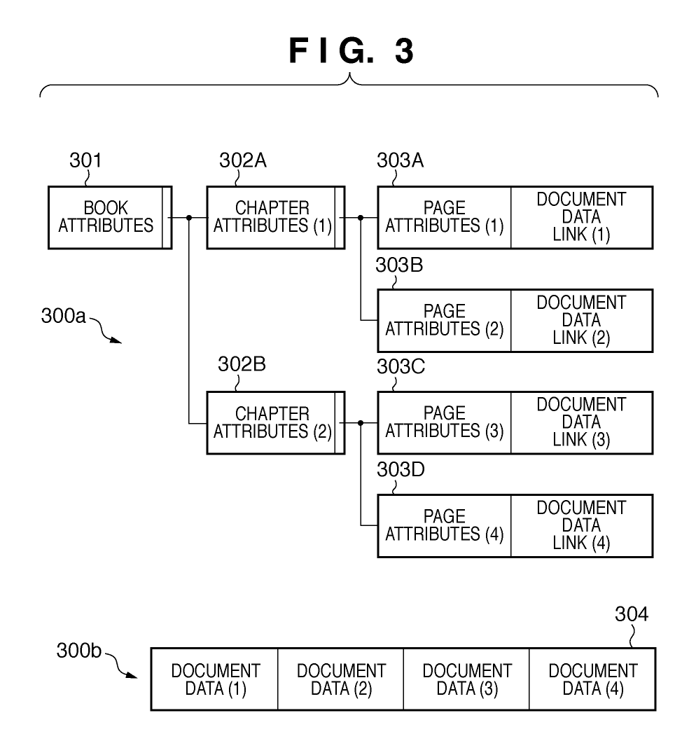

Reference numeral 300a in FIG. 3 schematically shows an example of a book file format. Reference numeral 300b schematically shows an example of the format of document data that is a data entity.

A book, chapters, and pages in the book file of this example are respectively indicated by corresponding nodes. One book file includes one book. The book and chapters include defined attribute values and links to lower layers as their entities because they are concepts to define the structure as a book. Each page has, as its entity, the data of the page output by an application program. Hence, each page includes the entity of a document page (document page data) and a link to each document page data in addition to the attribute values. Note that a print page to be output to a paper medium sometimes includes a plurality of document pages. This structure is not indicated by links but is indicated by attributes in the book, chapter, and page layers. That is, a book file (document image data) includes a plurality of sequenced pages (image data) each having one or more objects.

A book 301 defines book attributes and is linked to two chapters 302A and 302B. These links indicate that the book 301 includes the chapters 302A and 302B. The chapter 302A is linked to pages 303A and 303B, which indicates that the chapter 302A includes the pages. The pages 303A and 303B define attribute values and include links to document data (1) and (2) as their entities, respectively. That is, these links indicate that the entities of the pages 303A and 303B are the document data (1) and (2).

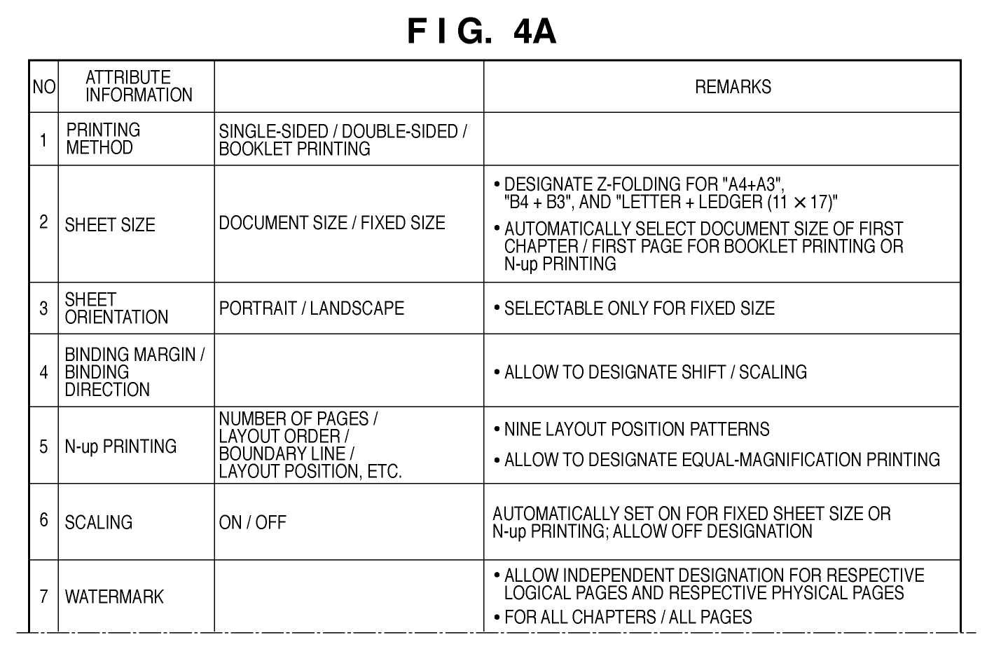

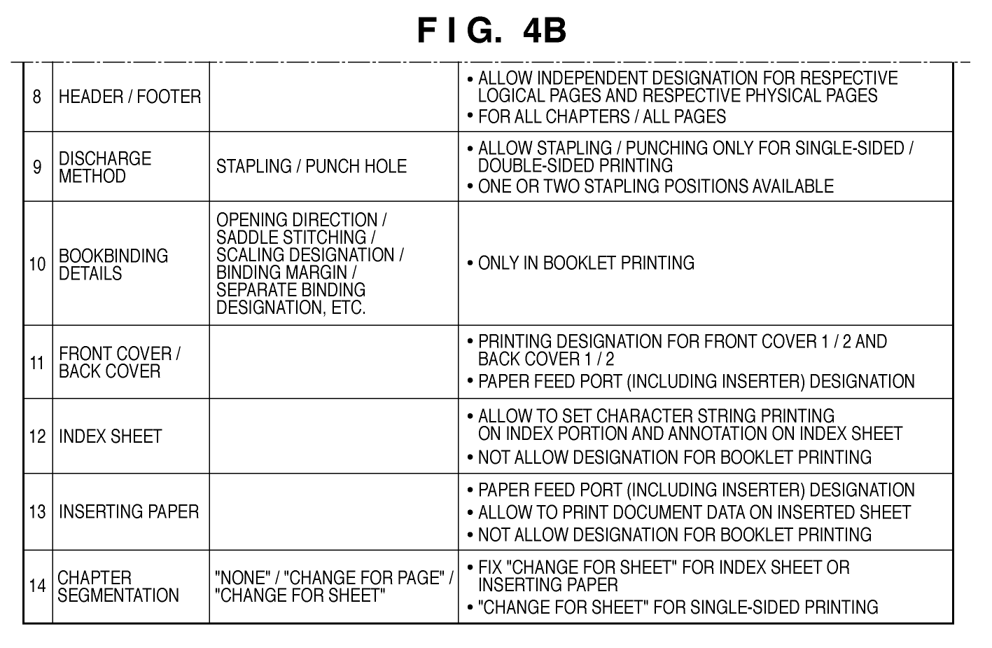

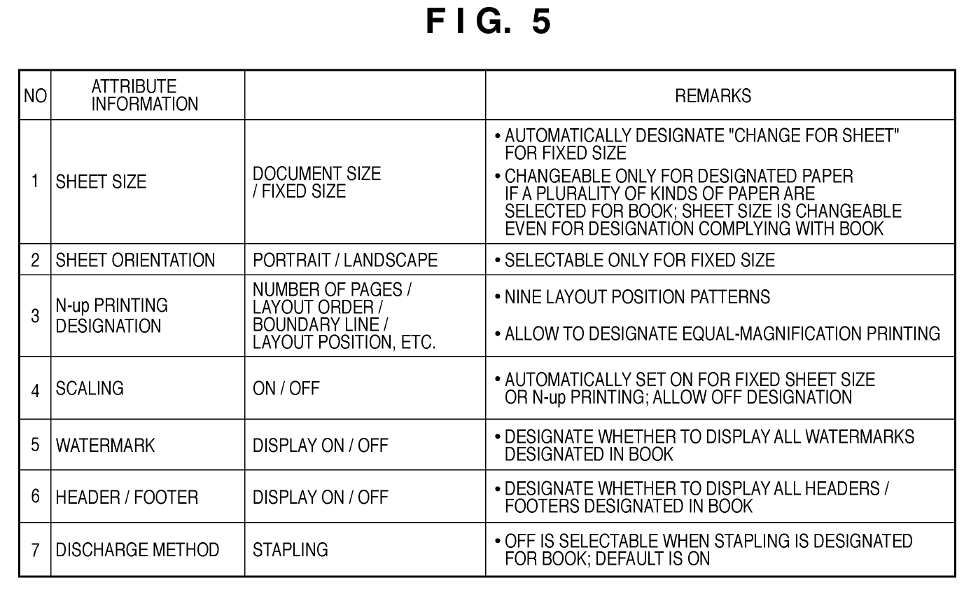

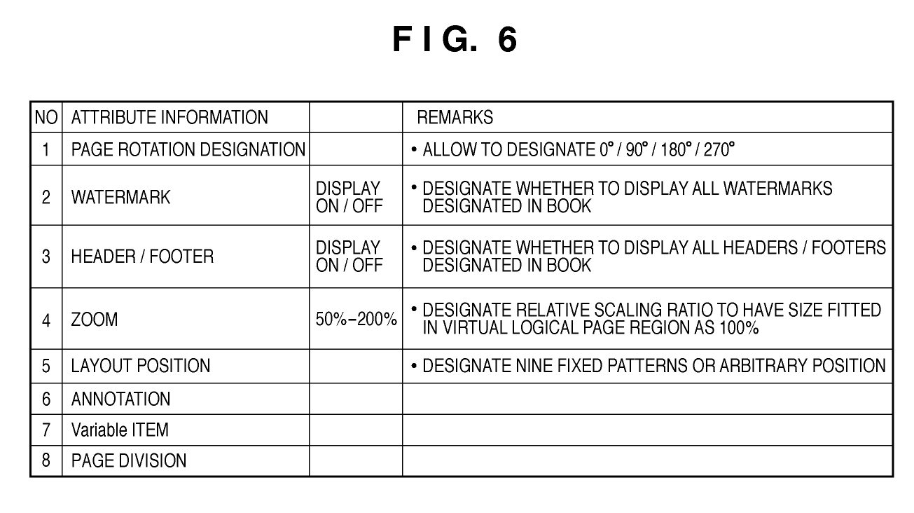

FIGS. 4A and 4B are views showing a list of book attributes. FIG. 5 is a view showing a list of chapter attributes. FIG. 6 is a view showing a list of page attributes. For items that overlap those of lower layers, attribute values of lower layers are preferentially adopted. For this reason, as for items included in only the book attributes, the values defined in the book attributes are effective throughout the book. However, as for items which overlap those of lower layers, these values indicate prescribed values if they are not defined in lower layers. Note that each item shown in FIGS. 4A, 4B, 5, and 6 does not always correspond to one item in practice, but may sometimes include a plurality of associated items. The relationship between the chapter attributes and the page attributes is the same as that between the book attributes and the attributes of a lower layer.

As is apparent from FIGS. 4A to 6, six items are unique to the book attributes: printing method, bookbinding details, front/back cover, index sheet, inserting paper, and chapter segmentation. These items are defined throughout a book. As printing method attributes, three values, i.e., single-sided printing, double-sided printing, and booklet printing can be designated. Booklet printing is a printing method that enables bookbinding by bundling a separately designated number of paper sheets, folding them into folio, and binding them. When booklet printing is designated, the direction of double-page spreading, the number of paper sheets to be bundled, and the like can be designated as the bookbinding details attribute.

The front/back cover attribute includes a designation of addition of paper sheets serving as front and back covers, and a designation of print contents for the added paper sheets when printing electronic document files included in a book. The index sheet attribute includes a designation of insertion of a separately prepared index sheet with tab to the printing apparatus as a chapter segmentation, and a designation of print contents to be printed on the index (tab). This attribute is valid when the printing apparatus to be used includes an inserter having an insertion function of inserting a paper sheet prepared independently of printing paper sheets to a desired position, or when a plurality of paper feed cassettes are usable. This also applies to the inserting paper attribute.

The inserting paper attribute includes a designation of insertion of paper sheets to be supplied from an inserter or a paper cassette as chapter segmentations, and a designation of a paper source when inserting paper.

The chapter segmentation attribute includes a designation of use of a new paper sheet, use of a new print page, or do-nothing at chapter segmentations. In single-sided printing, use of a new paper sheet and use of a new print page have the same significance. In double-sided printing, if “use of new paper sheet” is designated, successive chapters are never printed on one paper sheet. However, if “use of new print page” is designated, successive chapters may be printed on the obverse and reverse sides of one sheet.

As for the chapter attributes, there are no items unique to chapters, and all items overlap those of the book attributes. Hence, if definitions in the chapter attributes are different from those in the book attributes, values defined in the chapter attributes are used preferentially. Five items are common to the book attributes and the chapter attributes: sheet size, sheet orientation, N-up printing designation, scaling, and discharge method. Of these items, the N-up printing designation attribute is an item to designate the number of document pages to be included in one print page. Layout that can be designated are 1×1, 1×2, 2×2, 3×3, 4×4, and the like. The discharge method attribute is an item to designate whether to staple discharged paper sheets. The validity of this attribute depends on whether the printing apparatus to be used has a staple function.

Items unique to the page attributes include a page rotation attribute, zoom, layout designation, annotation, and page division. The page rotation attribute is an item to designate a rotation angle when laying out a document page on a print page. The zoom attribute is an item to designate the scaling ratio of document pages. The scaling ratio is designated to have the size of a virtual logical page region as 100%. The virtual logical page region is a region occupied by one document page when document pages are laid out in accordance with, for example, an N-up designation. For, for example, 1×1, the virtual logical page region corresponds to one print page. For 1×2, the virtual logical page region is obtained by reducing each side of a print page to about 70%.

Attributes common to the book, chapter, and page attributes are a watermark attribute and a header/footer attribute. A watermark is an image or a character string separately designated to be superimposed on data created by an application. A header and footer are watermarks printed on the top and bottom margins of each page. Note that as the header and footer, items such as a page number and a date/time that can be designated as variables are prepared. Note that the contents that can be designated in the watermark and header/footer attributes are common in the chapter and page attributes but are different in the book attributes. In the book attributes, the contents of a watermark and header/footer can be set. How to print a watermark and header/footer throughout the book can also be designated. On the other hand, in the chapter and page attributes, whether or not to print, in a chapter and page, the watermark and header/footer designated in the book attributes can be designated.

<Book File Generation Procedure>

A procedure of causing the bookbinding application 104 and the electronic document writer 102 to create a book file will be described below. The book file creation procedure is implemented as part of a book file edit operation of the bookbinding application 104.

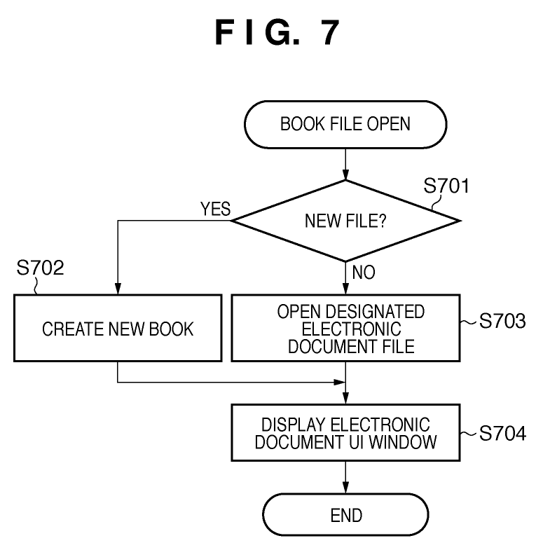

FIG. 7 is a flowchart illustrating an operation of causing the bookbinding application 104 to open a book file. The following operation is implemented by causing the CPU 201 to execute the bookbinding application 104.

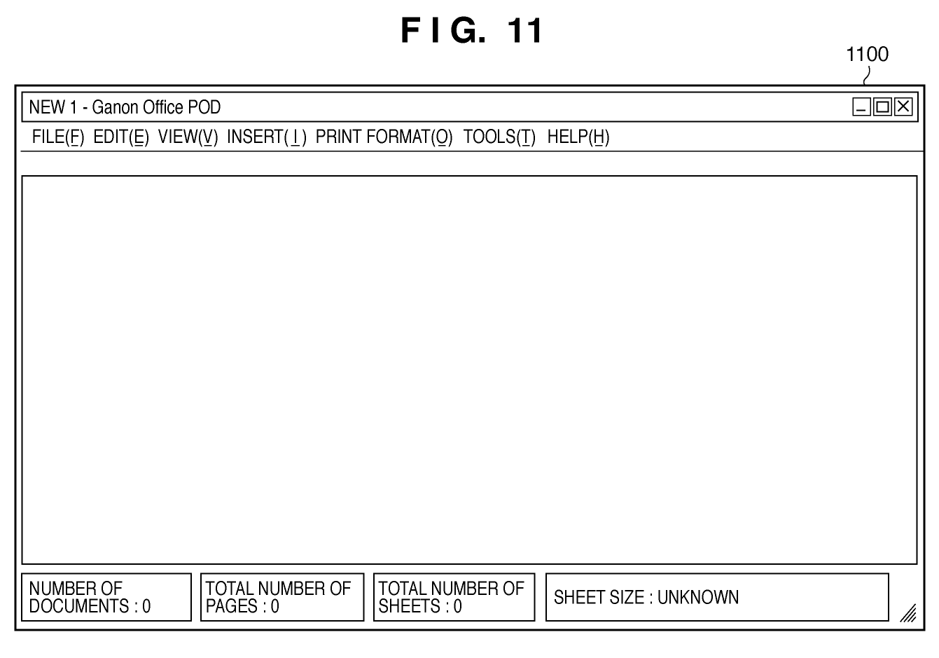

The bookbinding application 104 first determines whether a book file to be opened is an existing book file or a file to be newly created (step S701). When creating a new file, the bookbinding application 104 creates a new file including no chapters (step S702). The newly created file has only the book node in the example of FIG. 3. The book node has no links to chapter nodes. As book attributes, those prepared in advance for a newly created file are applied. Then, a user interface (UI) window to edit the new book file is displayed (step S704). FIG. 11 shows an example of a UI window displayed when a new book file has been created. In this case, the book file has no actual contents, and nothing is displayed in the book file display region of a UI window 1100.

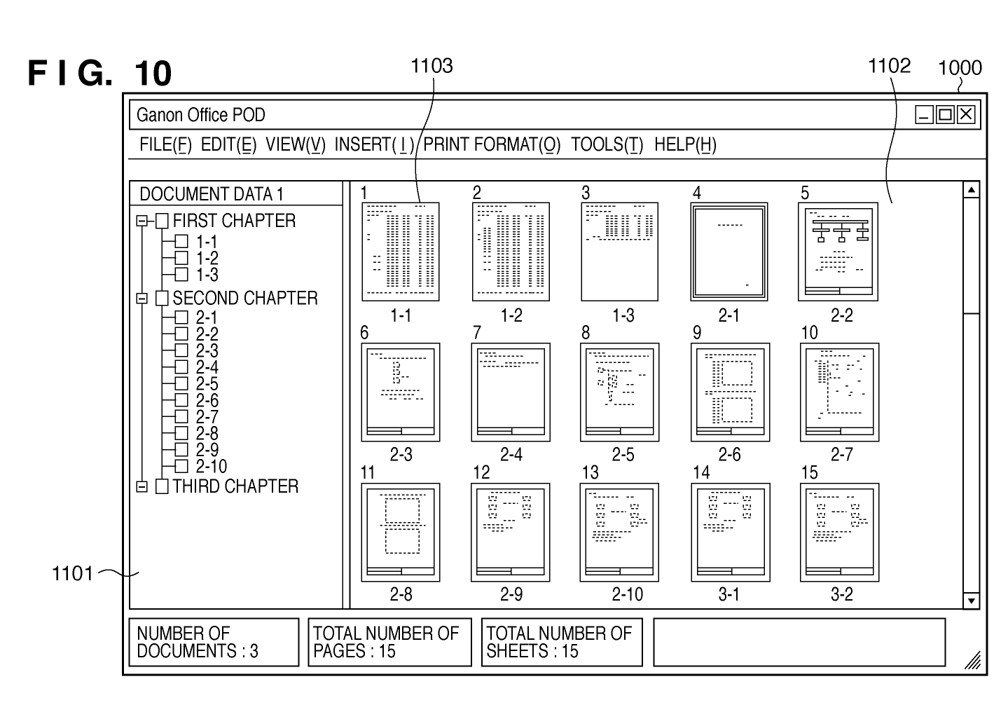

If an existing book file is present, the bookbinding application 104 opens the designated book file (step S703), and displays a user interface (UI) window in accordance with the structure, attributes, and contents of the book file. FIG. 10 shows an example of a UI window to display a designated book file. The UI window 1100 includes a tree portion 1101 representing the structure of the book, and a preview portion 1102 that displays a printed state. The tree portion 1101 displays chapters included in the book, and pages included in each chapter using a tree structure as indicated by 300a in FIG. 3. The pages displayed in the tree portion 1101 are document pages. The preview portion 1102 displays the contents of print pages in a reduced scale. The display order reflects the book structure.

Application data converted by the electronic document writer 102 into an electronic document file can be added to the opened book file as a new chapter. This function is called an electronic document import function. When an electronic document is imported to the book file newly created in accordance with the operation shown in FIG. 7, an entity is given to the book file. This function is activated by drag-and-drop of application data to, for example, the window shown in FIG. 10.

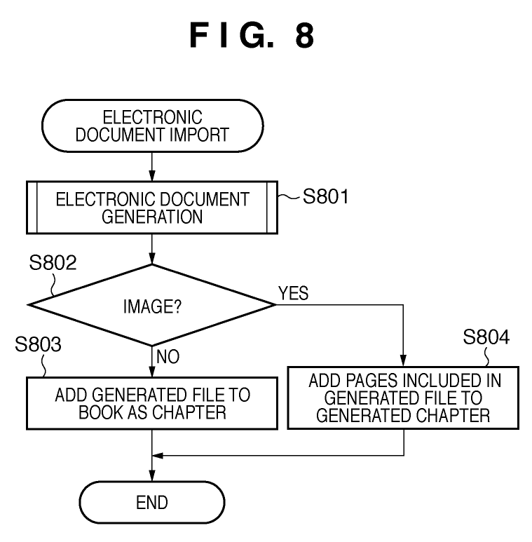

FIG. 8 illustrates a procedure of electronic document import. The application program that has generated designated application data is activated. While designating the electronic document writer 102 as a device driver, the application program prints and outputs the application data, thereby converting it into electronic document data (step S801). When conversion has ended, it is determined whether the converted data is image data (step S802). This determination is done based on, for example, the file extension of the application data. If the extension is, for example, “bmp”, the data is Windows bitmap data. If the extension is “jpg”, the data is JPEG-compressed image data. If the extension is “tiff”, the data is image data in the tiff format. Such image data can directly generate an electronic document file without activating the application. Hence, the process in step S801 can be omitted.

If the application data is not image data, the electronic document file generated in step S801 is added to the book of the currently opened book file as a new chapter (step S803). Of the chapter attributes, items common to the book attributes have values copied from the book attributes. For the remaining items, prescribed values prepared in advance are set.

If it is determined in step S802 that the application data is image data, document pages included in the electronic document file generated in step S801 are added to a designated chapter in principle, instead of adding a new chapter (step S804). If the book file is a newly created file, a new chapter is created, and the pages of the electronic document file are added as pages belonging to the chapter. Of the page attributes, items common to an upper layer have the same attribute values as in the upper layer. Items whose attribute values should be inherited from the application data to the electronic document file are given those values. For example, if the application data has an N-up designation, the page attributes inherit the attribute value. In this way, a new book file is created, or a new chapter is added.

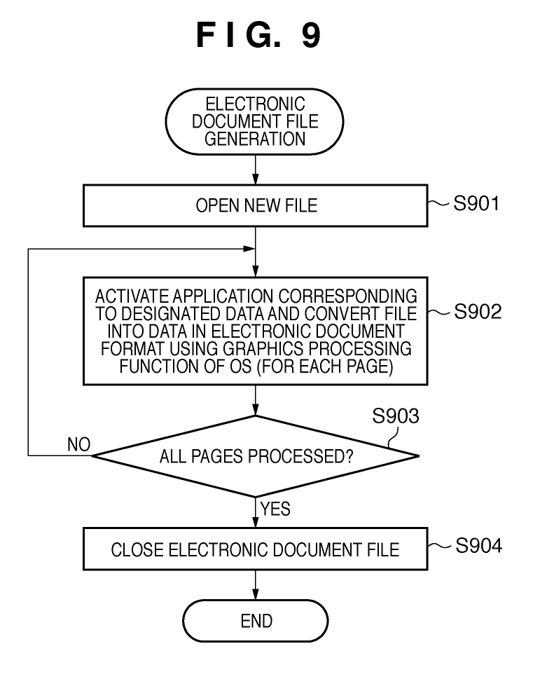

FIG. 9 is a flowchart illustrating an operation of causing the electronic document writer 102 to generate an electronic document file. First, the electronic document writer 102 creates a new electronic document file and opens it (step S901). An application corresponding to the designated application data is activated to output an output command to the output module of the OS while designating the electronic document writer as a device driver. The output module causes the electronic document writer 102 to convert the received output command into data in an electronic document format, and outputs it (step S902). The output destination is the electronic document file opened in step S901. It is determined whether all designated data have been converted (step S903). If the conversion has ended, the electronic document file is closed (step S904). The electronic document file generated by the electronic document writer 102 is the file including the document data entity indicated by 300b in FIG. 3.

It is possible to thus create a book file from application data.

<Book File Edit>

The chapters and pages of the generated book file can undergo, for example, the following edit operations.

(1) new addition, (2) delete, (3) copy, (4) cut, (5) paste, (6) move, (7) change chapter name, (8) re-assign page number name, (9) insert cover, (10) insert inserting paper, (11) insert index sheet, and (12) page layout for each document page.

An operation of canceling an edit operation that was made once, and an operation of redoing the canceled operation are also possible. These edit functions allow edit operations such as integration of a plurality of book files, re-layout of chapters and pages in a book file, deletion of chapters and pages in a book file, layout change of document pages, and insertion of inserting paper and index sheets. The results of these operations are reflected on the attributes shown in FIGS. 4 and 5 or the structure of the book file. For example, when an operation of newly adding a blank page is performed, the blank page is inserted to a designation portion. The blank page is handled as a document page. When the layout of document pages is changed, the change contents are reflected on the attributes such as the printing method, N-up printing, front/back cover, index sheet, inserting paper, and chapter segmentation.

<Output of Book File>

The end goal of the book file created and edited in the above-described way is print output. When the user selects a file menu in the UI window 1100 of the bookbinding application shown in FIG. 10, and then selects “print”, the designated output device prints and outputs the data. The bookbinding application 104 creates a job ticket from the currently opened book file, and transmits it to the electronic document despooler 105. The electronic document despooler 105 converts the job ticket into an output command of the OS, and transmits it to the output module. The output module causes the designated printer driver 106 to generate a command suitable for the device, and transmits the command to the device.

The job ticket is data which has a structure including a document page as a minimum unit. The structure in the job ticket defines the layout of document pages on paper sheets. One job ticket is issued in correspondence with one job. The uppermost node is named “document”, which defines the attributes of the whole document such as double-sided printing/single-sided printing. Paper nodes are associated with the document node, which include attributes such as the identifiers of paper sheets to be used, and a designation of a paper feed port in a printer. A node of a sheet to be printed using the paper is associated with each paper node. One sheet corresponds to one paper sheet. A print page (physical page) is associated with each sheet. In single-sided printing, one physical page is associated with one sheet. In double-sided printing, two physical pages are associated with one sheet. Document pages to be laid out on a physical page are associated with the physical page. The attributes of physical pages include the layout of the document pages.

The electronic document despooler 105 converts the above-described job ticket into an output command to the output module.

<Contents of Preview Display>

When the bookbinding application opens a book file, the user interface window 1100 shown in FIG. 10 is displayed, as described above. The tree portion 1101 displays a tree representing the structure of the currently opened book (to be referred to as a “book of interest” hereinafter). The preview portion prepares, for example, the following three display methods in accordance with user designations.

The first display mode is called a document view that directly displays document pages. In the document view mode, the contents of document pages belonging to the book of interest are displayed in a reduced scale. The layout is not reflected on the display in the preview portion 1102. The second display mode is a print view mode. In the print view mode, the preview portion 1102 displays document pages while reflecting their layout. The third display mode is a simple print view mode. In the simple print view mode, not the contents of document pages but only their layout is reflected on the display in the preview portion 1102.

<Staple Control>

Staple control to be executed by the bookbinding application 104 of the computer 100 connected to a printer having a staple function will be described next.

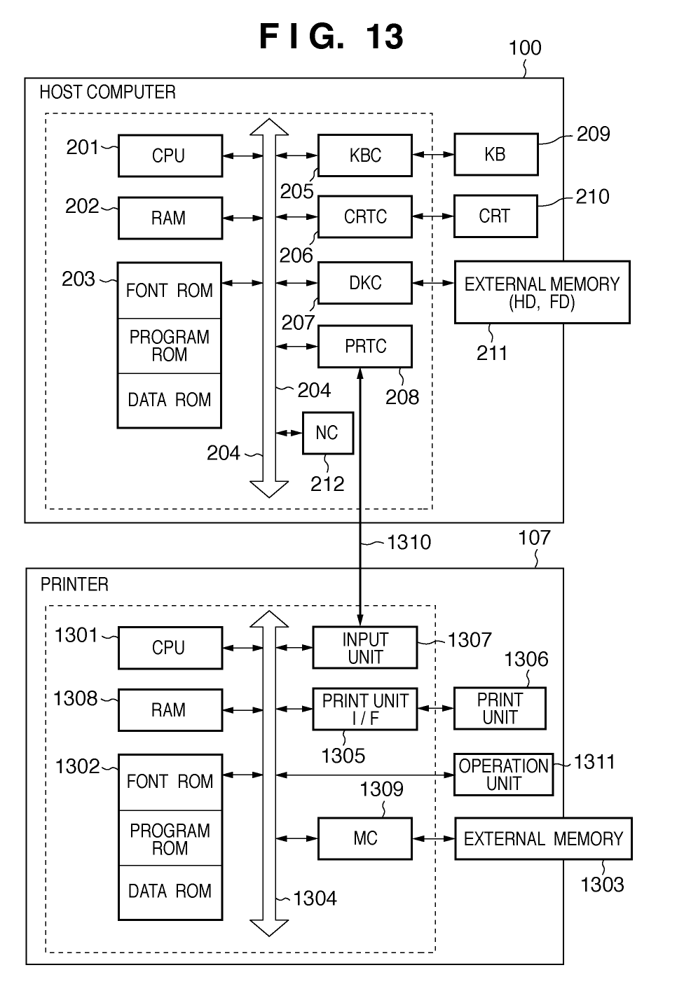

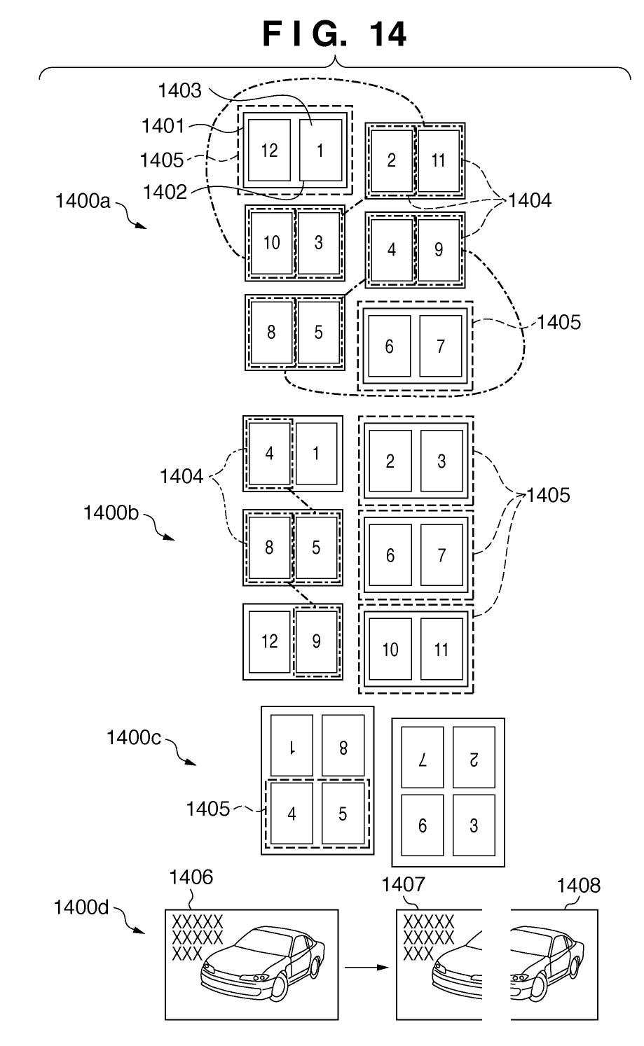

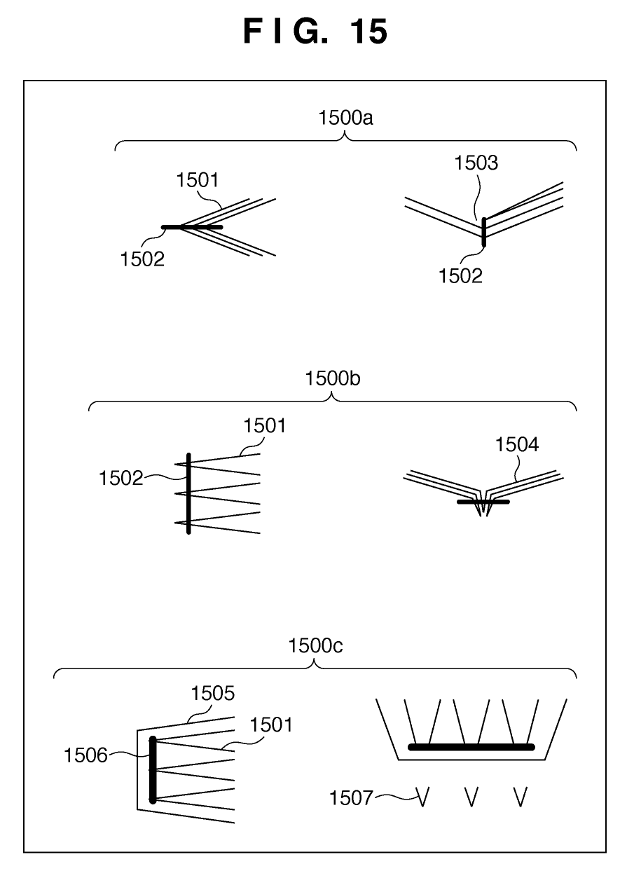

FIG. 13 is block diagram showing the arrangement of a staple control system. As shown in FIG. 13, the staple control system includes the computer 100 shown in FIG. 2, and the printer 107 having a staple function.

The printer 107 includes a printer CPU 1301. The printer CPU executes a control program stored in the program ROM of a ROM 1302 or a control program stored in an external memory 1303. The CPU thus outputs an image signal as output information to a print unit (printer engine) 1306 via a print unit I/F 1305 connected to a system bus 1304. The program ROM of the ROM 1302 stores, for example, the control program of the CPU 1301. The font ROM of the ROM 1302 stores, for example, font data to be used when generating output information. The data ROM of the ROM 1302 stores, for example, information to be used on the computer 100 if the printer includes no external memory 1303 such as a hard disk.

The CPU 1301 can communicate with the computer 100 via an input unit 1307 and notify the computer 100 of, for example, information in the printer 107. A RAM 1308 is designed to function as the main memory or work area of the CPU 1301 and to be able to extend the memory capacity using an optional RAM connected to an add-on port (not shown).

Note that the RAM 1308 serves as, for example, an output information rasterization area, environment data storage area, or NVRAM. A memory controller (MC) 1309 controls access to the above-described external memory 1303 such as a hard disk (HD) or IC card. The external memory 1303 is optionally connected to store font data, emulation programs, form data, and the like. An operation unit 1311 includes switches for operations and LED indicators.

Not the above-described single external memory 1303 but a plurality of external memories may be provided. Each external memory may include an optional card in addition to built-in fonts, and store a program to interpret a printer control language of a different language system. The printer may include an NVRAM (not shown) and store printer mode setting information from the operation unit 1311.

<Operation Sequence of System>

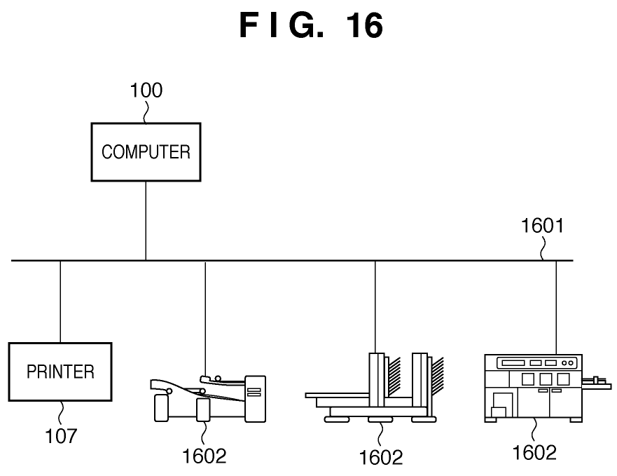

FIG. 16 shows the constituent elements of a bookbinding system according to the first embodiment. Reference numeral 1601 denotes a network such as a LAN or WAN; and 1602, cutting machines. That is, the bookbinding system is formed by connecting the computer 100, the printer 107, and the cutting machines 1602 via the network 1601 such as a LAN.

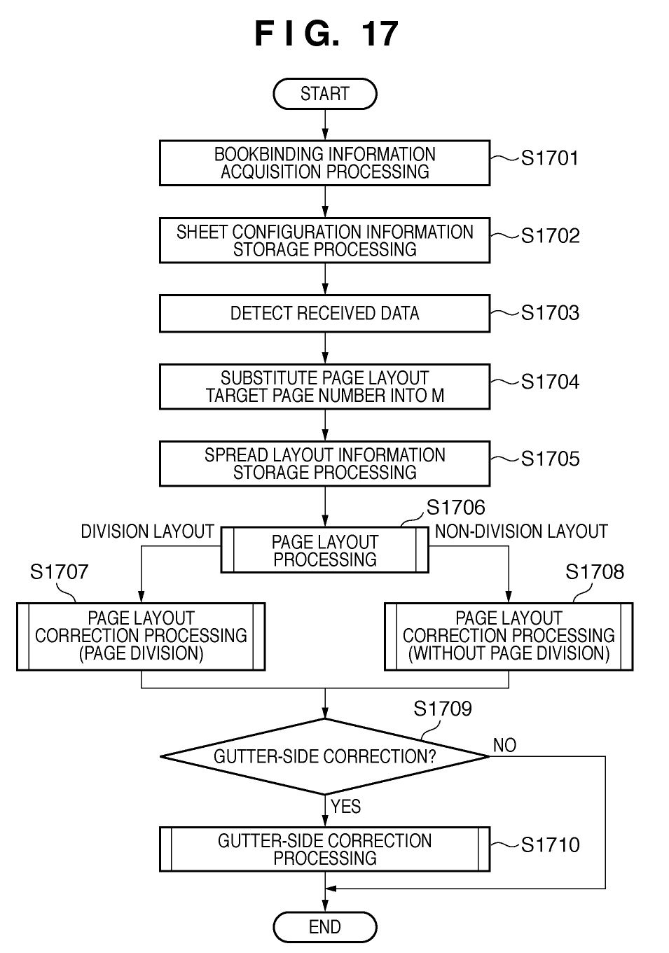

FIG. 17 is a flowchart illustrating overall processing according to the first embodiment. The following operation is implemented by causing the CPU 201 to execute the bookbinding application 104.

In step S1701, the bookbinding application 104 acquires bookbinding information. More specifically, the bookbinding application 104 acquires configuration information from the printer 107 and the cutting machine 1602 which are output destinations connected via the network 1601 such as a LAN, and acquires information of usable bookbinding methods. For example, the bookbinding application 104 acquires information of a bookbinding method designated by an operator via a UI for bookbinding method designation.

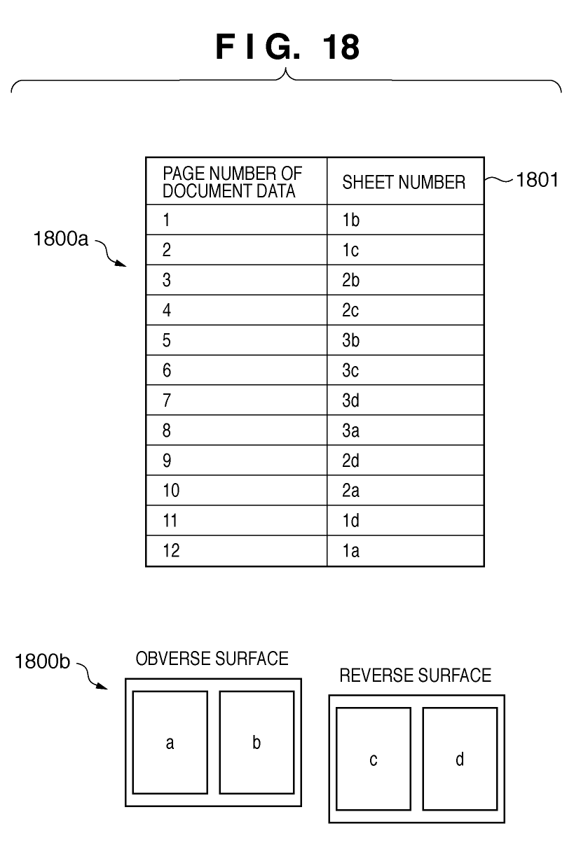

In step S1702, the bookbinding application 104 acquires sheet configuration information and stores it in the RAM 202 of the computer. The bookbinding application 104 acquires the sheet configuration information from the bookbinding method formation acquired in step S1701. The acquired sheet configuration information may be managed in a sheet configuration information list 1801 as indicated by 1800a in FIG. 18. Reference numeral 1800b represents a conceptual illustration of the definition of a sheet configuration. For, for example, a saddle-stitched book, the left side of the observe surface of a sheet is defined as “a”, and the right side as “b”. The left side of the reverse surface is defined as “c”, and the right side as “d”. That is, the sheet configuration information list 1801 defines the layout position of each page of document data. For example, page 1 laid out on the right side of the observe surface is managed by assigning a sheet number 1b. Page 2 laid out on the left side of the reverse surface is managed by assigning a sheet number 1c.

In step S1703, the bookbinding application 104 recognizes received data.

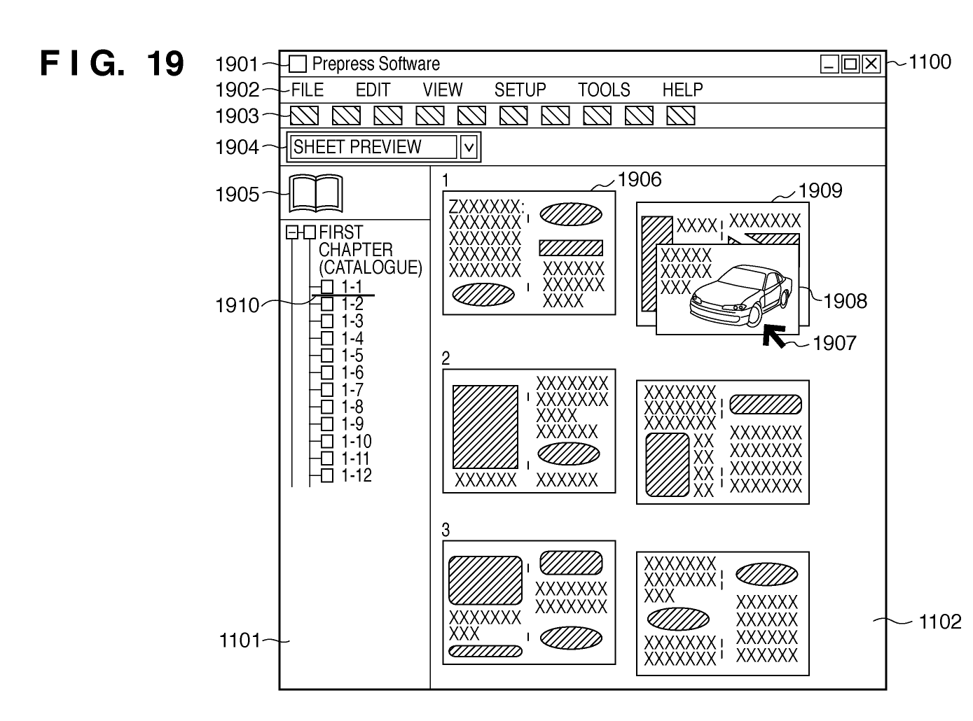

FIG. 19 is a view of a UI of the bookbinding application 104. Reference numeral 1901 denotes a title bar; 1902, a menu tool bar; 1903, a tool bar; 1904, a list box to switch the type of preview to be displayed in the preview region 1102; 1905, an icon indicating designated bookbinding setting; 1906, a preview image of document data that has undergone page layout; 1907, a mouse pointer; 1908, received document data; 1909, an indicator line representing the position of the received document data; and 1910, an indicator line representing the position of the received document data in the tree portion 1101. Document data reception is executed by dragging and dropping document data to be received to a document reception position. When the user drags document data into the preview portion 1102, the document reception position is indicated by the indicator lines 1909 and 1910 upon drop. When the user drops document data at a position to lay out a spread page, the print application detects document reception. The document data reception method is not limited to drag-and-drop. Any other method such as designation on a menu is also usable.

In step S1704, the bookbinding application 104 specifies the page layout target page number based on the position of document reception in step S1703, and substitutes the number into a constant M.

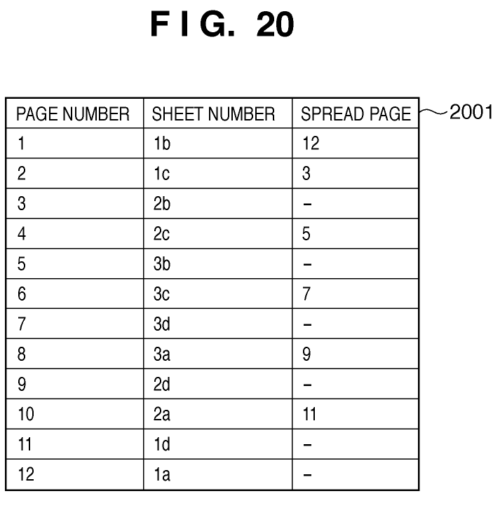

In step S1705, the bookbinding application 104 stores spread page information in the sheet configuration information list 1801. FIG. 20 shows the sheet configuration information list 1801 added with spread page information 2001. In, for example, a 12 pages long saddle-stitched book, the number of a spread page corresponding to page number “1” is “12”. The number of a spread page corresponding to page number “2” is “3”. The number of a spread page corresponding to page number “3” is “2”. However, such a correspondence relationship from a larger page number to a smaller one is excluded for convenience. Hence, the number of a spread page corresponding to page number “3” is “-”. In this way, spread page numbers are stored in correspondence with the page numbers in the sheet configuration information list 1801.

In step S1706, the bookbinding application 104 lays out the received document data on pages. The page layout processing will be described later in detail. If the bookbinding application 104 has determined in step S1706 to do layout by dividing the received document data, the process advances to step S1707. If the bookbinding application 104 has determined in step S1706 to do layout without dividing the received document data, the process advances to step S1708.

In step S1707, the bookbinding application 104 divides the received document data, lays it out on pages, and corrects the layout. In step S1708, the bookbinding application 104 lays out the received document data on pages without dividing, and corrects the layout.

In step S1709, the bookbinding application 104 determines whether to correct the gutter side of booklet printing. To correct the gutter side, the process advances to step S1710. In step S1710, the print application corrects the gutter side in consideration of the property of the bookbinding method. The gutter-side correction processing will be described later in detail.

<Details of Page Layout Processing (Step S1706)>

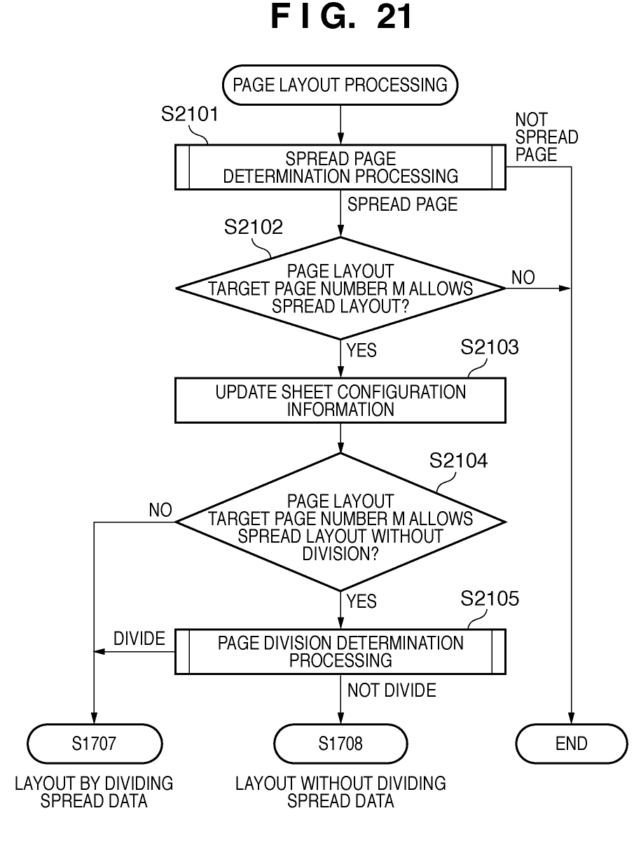

FIG. 21 is a flowchart of page layout processing.

In step S2101, the bookbinding application determines, based on the property and bookbinding setting of the received document data, whether the received document data is data of a spread page. The spread page determination processing will be described later in detail. If the bookbinding application has determined the received document data as a spread page, the process advances to step S2102. If the bookbinding application has determined that the received document data is spread page data, the processing ends, and normal page layout processing is performed.

In step S2102, the bookbinding application 104 determines whether the page layout target page number M stored in step S1704 of FIG. 17 indicates a page that allows spread layout. More specifically, the bookbinding application 104 refers to the sheet configuration information list, thereby determining whether the page layout target page number M represents that spread layout is possible. If a spread page corresponding to the page layout target page number M exists, the spread layout is determined to be possible. On the other hand, if no spread page corresponding to the page layout target page number M exists, the page the spread layout is determined to be impossible. If the bookbinding application 104 has determined that the page number M indicates a page that enables spread layout, the process advances to step S2103. If the bookbinding application 104 has determined that the page number M indicates a page that does not allow spread layout, the processing ends. If spread page layout is impossible in view of the sheet configuration, the page layout processing of the received data terminates as an error. Alternatively, the received document data is laid out not as a spread but as one page, and the processing ends.

In step S2103, the bookbinding application 104 updates the sheet configuration information. Upon determining in step S2102 that the page layout target page number M represents that spread layout is possible, the bookbinding application 104 updates the sheet configuration information stored in step S1705 described above. When a spread page (i.e., two physical pages) is received, the total number of pages increases, and therefore, the update processing is necessary.

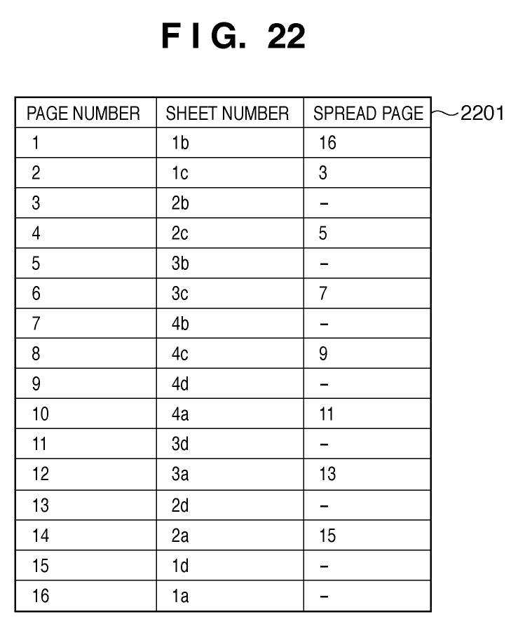

FIG. 22 shows an example of the above-described sheet configuration information list in FIG. 20 updated by the process in step S2103. Reference numeral 2201 denotes an updated sheet configuration information list. Since two pages corresponding to the spread page are added to the 12 pages long saddle-stitched book, the number of sheets to be output changes from 3 to 4, resulting in a 16 pages long saddle-stitched book. The sheet configuration information list is updated to correspond to the 16 pages long saddle-stitched book.

In step S2104, the bookbinding application 104 determines whether the page layout target page number M indicates a page that allows spread layout without page division. More specifically, the bookbinding application 104 refers to the sheet configuration information list updated in step S2103, thereby determining whether the page layout target page number M represents that spread layout is possible without page division. For example, the spread page corresponding to page number 1 is 16. The sheet numbers of these pages are 1b and 1a. Since they are two adjacent pages on the same surface of a single sheet (board), the spread layout is determined to be possible. If it is determined that the page layout target page number M represents that spread layout is possible without page division, the process advances to step S2105. If it is determined that the page layout target page number M represents that spread layout is not possible without page division, the process advances to step S1707 in FIG. 17.

In step S2105, the bookbinding application 104 determines whether the received document data determined as a spread page in step S2101 requires page division. The division determination processing will be described later in detail. To perform page division of the received document data, the process advances to step S1707 of the general flowchart in FIG. 17. Not to perform page division of the received document data, the process advances to step S1708 in FIG. 17.

<Details of Spread Page Determination Processing (Step S2101)>

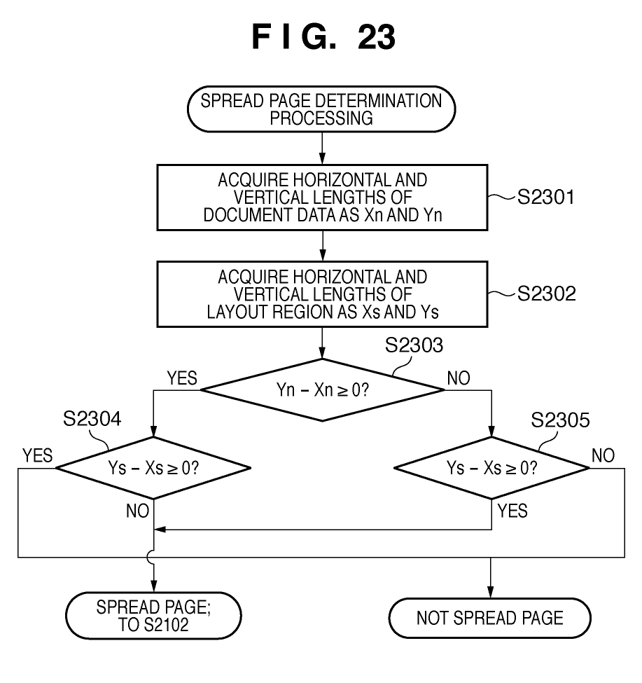

FIG. 23 is a flowchart of spread page determination processing.

In step S2301, the bookbinding application 104 acquires the horizontal and vertical lengths of the received document data, and stores them in constants Xn and Yn.

In step S2302, the bookbinding application 104 acquires the vertical and horizontal lengths of the layout region of one page after bookbinding, and stores them in constants Xs and Ys.

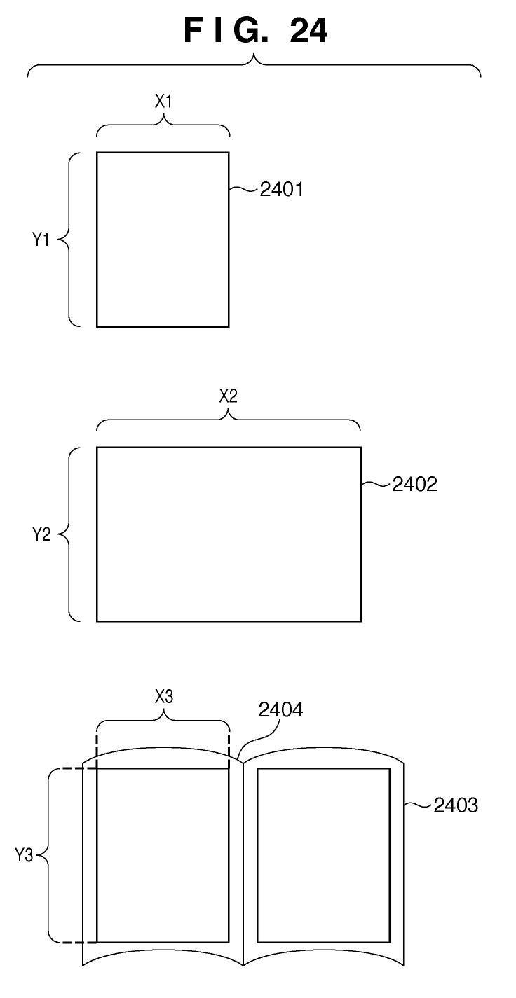

FIG. 24 is a conceptual view of received document data and the layout region of one page after bookbinding. Reference numerals 2401 and 2402 denote received document data. The document data 2401 is of a portrait type. The document data 2402 is of a landscape type. Reference numeral 2403 represents a conceptual illustration of a finished book; and 2404, a layout region of one page after bookbinding. In steps S2303 to S2305 to be described later, the vertical and horizontal lengths of the document data and the layout region acquired in steps S2301 and S2302 are compared. If the ordering of the vertical and horizontal lengths of the document data is reverse to that of the layout region, the document data is determined to be document data of a spread page.

In step S2303, the bookbinding application 104 determines whether a value obtained by subtracting the horizontal length of the document data from its vertical length is 0 or more. If the value obtained by subtracting the horizontal length of the document data from its vertical length is 0 or more, the process advances to step S2304. If the value obtained by subtracting the horizontal length of the document data from its vertical length is smaller than 0, the process advances to step S2305. Note that the ratio (aspect ratio) of the vertical and horizontal lengths may be calculated and determined in place of the difference between the vertical and horizontal lengths.

In step S2304, the bookbinding application 104 determines whether a value obtained by subtracting the vertical length of the layout region from its horizontal length is 0 or more. If the value obtained by subtracting the vertical length of the layout region from its horizontal length is 0 or more, the spread page determination condition is not satisfied. That is, the document data is determined not to be a spread page. In this case, the process advances to the above-described processing for document data that is not a spread page. If the value obtained by subtracting the vertical length of the layout region from its horizontal length is smaller than 0, the spread page determination condition is satisfied. That is, the document data is determined to be a spread page. In this case, the process advances to step S2102 described above.

In step S2305, the bookbinding application 104 determines whether a value obtained by subtracting the vertical length of the layout region from its horizontal length is 0 or more. If the value obtained by subtracting the vertical length of the layout region from its horizontal length is 0 or more, the spread page determination condition is satisfied. That is, the document data is determined to be a spread page. In this case, the process advances to step S2102 described above. If the value obtained by subtracting the vertical length of the layout region from its horizontal length is smaller than 0, the spread page determination condition is not satisfied. That is, the document data is determined not to be a spread page. In this case, the process advances to the above-described processing for document data that is not a spread page. For example, when laying out the document data 2401 in FIG. 24 in the layout region 2404 of the page,

Y1−X1>0

Y3−X3>0

Hence, the document data 2401 is determined not to be a spread page. When laying out the document data 2402 in FIG. 24 in the layout region 2404 of the page,

Y2−X2<0

Y3−X3>0

Hence, the document data 2401 is determined to be a spread page.

<Details of Page Division Determination Processing (Step S2105)>

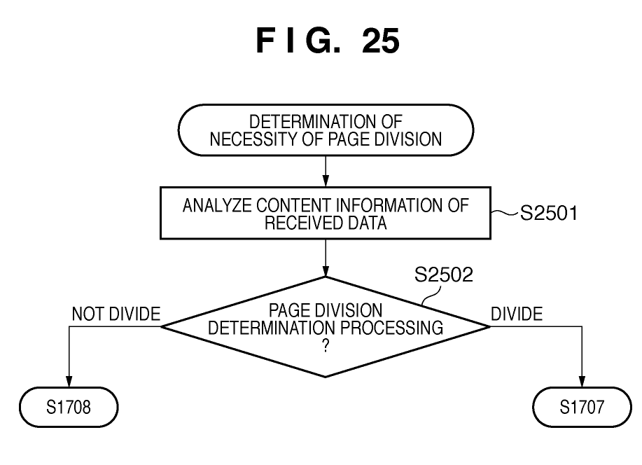

FIG. 25 is a flowchart of page division determination processing.

In step S2501, the bookbinding application 104 analyzes the content information of the received document data. The content information includes information of contents (objects) such as a text, image, and graphic rendered in the page. The print application analyzes the internal data of the document data, and acquires the position information of each rendered content. The bookbinding application executes division determination by analyzing each acquired position information and determining whether a content across a dividing line exists.

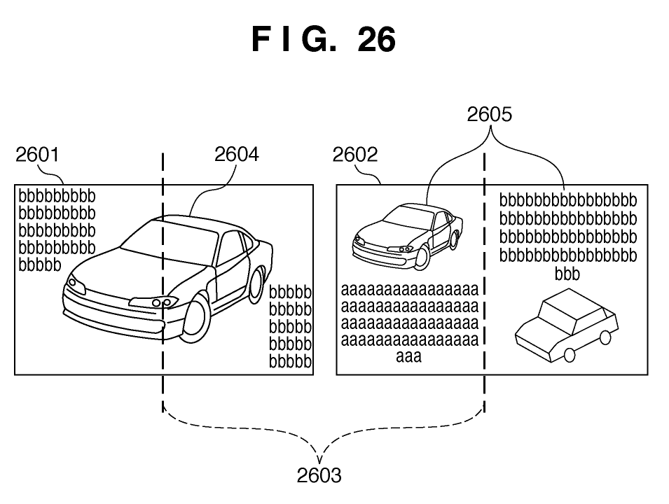

FIG. 26 is a view showing the concept of content information analysis processing in step S2501. Reference numerals 2601 and 2602 denote received document data; and 2603, a dividing line that divides pages. In the document data 2601, a content 2604 is rendered across the dividing line 2603.

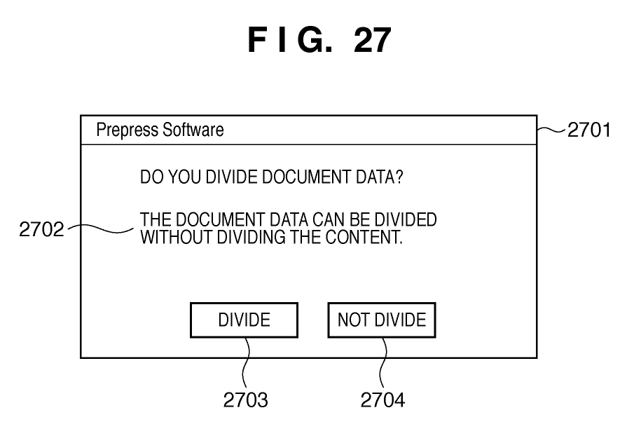

In step S2502, the bookbinding application 104 determines based on the analysis result in step S2501 whether to execute page division. For example, to receive a division instruction from the user, a message shown in FIG. 27 is displayed on the screen in accordance with the processing result in step S2501.

FIG. 27 is a view of a message dialogue (accepting unit) to receive an instruction to or not to divide document data. Reference numeral 2701 represents an overview of the message dialogue; 2702, a message text. The contents of the message text change in accordance with the processing result in step S2501. For example, if page layout is preferably done without page division of the document data (2601 in FIG. 26), a warning message “if you divide the document data, the content may be divided” is displayed, and the operator is promoted to determine. On the other hand, if the document data can be divided for page layout (2602 in FIG. 26), a warning message “the document data can be divided without dividing the content” is displayed, and the operator is promoted to determine. The operator presses a button 2703 to instruct division. The operator presses a button 2704 to instruct division inhibition. Upon detecting that the operator has pressed the button 2704, the process advances to step S1708 to perform processing without page division. Upon detecting that the operator has pressed the button 2703, the process advances to step S1707 to perform processing with page division.

The bookbinding application may automatically perform division determination. For, for example, the document data 2601 including a content (object) which is divided into a plurality of pages across the dividing line, it is determined that page layout is preferably done without page division of the document data. On the other hand, the document data 2602 include contents 2605 which never come across the dividing line 2603. Hence, the bookbinding application may determine that page layout of the document data 2602 can be done by dividing the page.

<Details of Page Layout Correction Processing (page division) (Step S1707)>

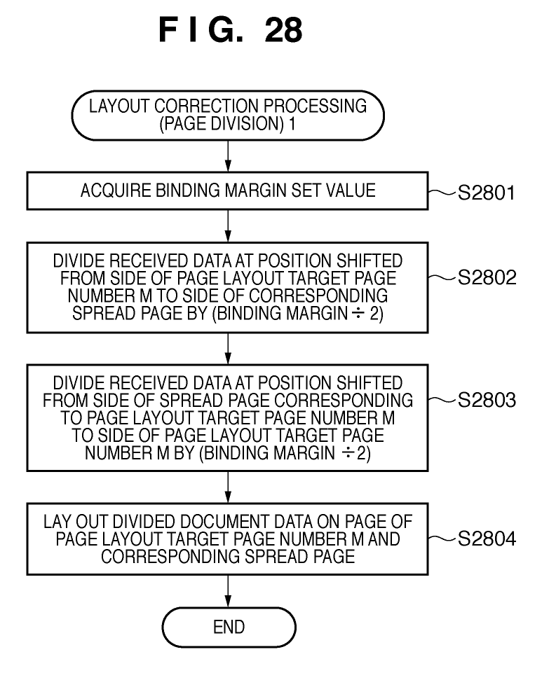

FIG. 28 is a flowchart illustrating division position correction to be performed as page layout correction processing (page division).

In step S2801, the bookbinding application 104 acquires a binding margin width from the information of the designated bookbinding method.

In step S2802, the bookbinding application 104 divides the document data at a position shifted from the side of the page layout target page number M to the side of the corresponding spread page of the document data by (binding margin÷2).

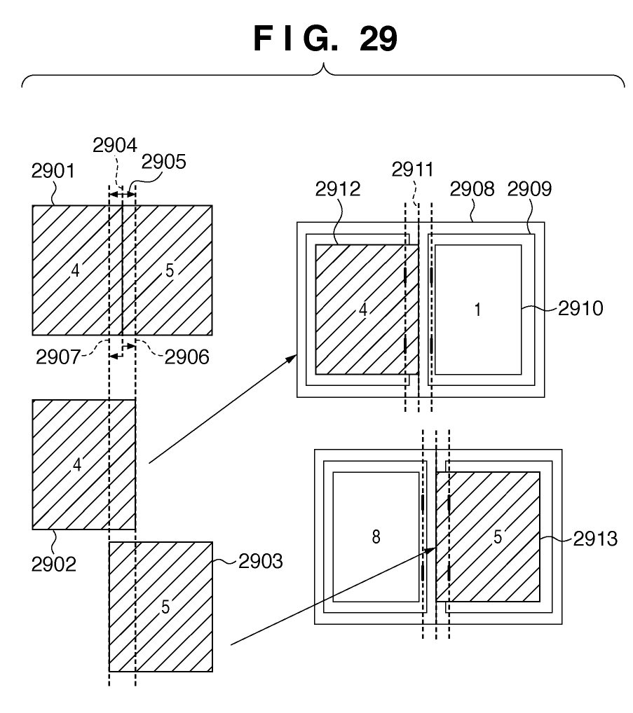

FIG. 29 is a view showing the concept of division position correction. Reference numeral 2901 denotes received document data; and 2904, a center line. Assume that the page layout target page number M is 4, and the corresponding to spread page number is 5. The binding margin width is represented by 2905. In the process of step S2802, the page is divided at a position 2906 shifted from the side of the page layout target page number M (the left side of the document data 2901) to the side of the corresponding spread page by a width corresponding to (binding margin 2905÷2). Reference numeral 2902 denotes divided document data.

In step S2803, the bookbinding application 104 divides the document data at a position shifted from the side of the spread page corresponding to the page layout target page number M to the side of the page layout target page number M by (binding margin÷2). That is, the process described in step S2802 is executed on the spread page side. The page is divided at a position 2907 shifted from the side of the spread page corresponding to the page layout target page number M (the right side of the document data 2901) to the side of the page layout target page number M by a width corresponding to (binding margin 2905÷2). Reference numeral 2903 denotes divided document data.

In step S2804, the bookbinding application 104 lays out the document data divided in steps S2802 and S2803 in corresponding layout regions. More specifically, the document data divided in step S2802 is laid out in the layout region of the page layout target page number M. On the other hand, the document data divided in step S2803 is laid out in the layout region of the spread page corresponding to the page layout target page number M. Reference numeral 2908 denotes a sheet; 2909, a layout region; 2910, document data laid out; 2911, a center line of the sheet; 2912, a page layout result of the divided document data 2902 in the layout region; and 2913, a page layout result of the divided document data 2903 in the layout region. Since the document data is divided at the position shifted outward, the document overlaps the binding margin. This processing makes it possible to read the spread page without any blank at the gutter-side portion when the spread page of the finished book is opened.

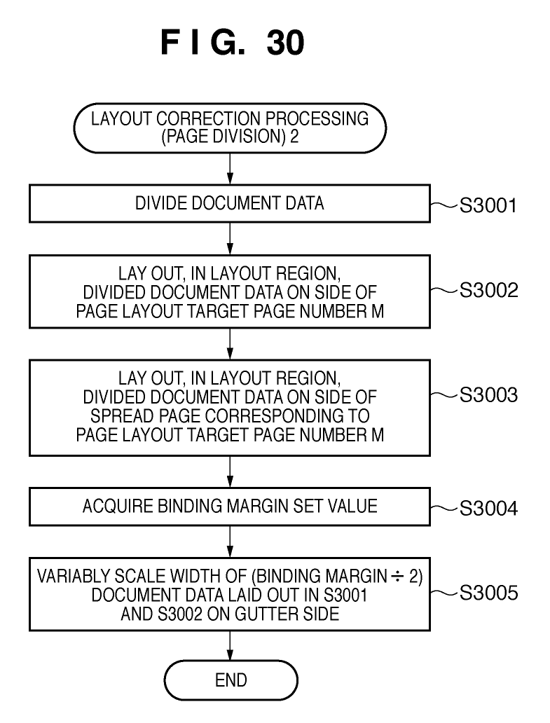

FIG. 30 is a flowchart illustrating variable scaling processing to be performed as page layout correction processing (page division).

In step S3001, the bookbinding application 104 divides received document data.

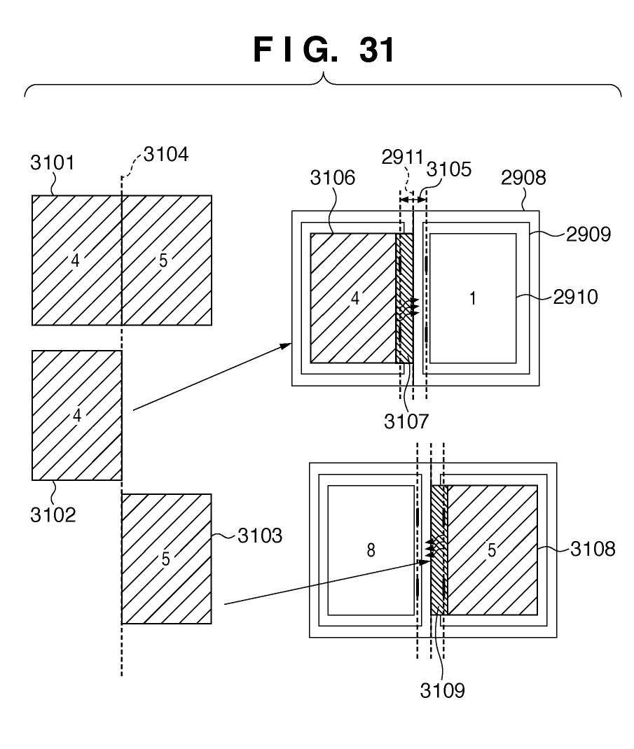

FIG. 31 is a view showing the concept of variable scaling processing. Reference numeral 3101 denotes document data; and 3104, a center line. The page division processing in step S3001 is done by dividing the document data at the center line 3104.

In step S3002, the bookbinding application 104 performs, in the layout region of the page layout target page number M, page layout 3106 of document data 3102 on the side of the page layout target page number M divided in step S3001.

In step S3003, the bookbinding application 104 performs, in a layout region 3108 of the spread page corresponding to the page layout target page number M, page layout of document data 3103 on the side of the spread page divided in step S3001.

In step S3004, the bookbinding application 104 acquires a binding margin width 3105 from the information of the designated bookbinding method.

In step S3005, the bookbinding application 104 variably scales gutter-side portions 3107 and 3109 of the document data that has undergone the page layout in steps S3001 and S3002 by a width corresponding to (binding margin÷2) (image modification unit). For example, the peripheral portion having the width of (binding margin÷2) on the binding side is variably scaled toward the gutter, thereby making the document data overlap the binding margin.

This processing makes it possible to read the spread page without any blank at the gutter-side portion when the spread page of the finished book is opened. Variable scaling is done here in consideration of the property that the visibility lowers toward the page center in a finished book. Enlargement is performed coarsely at the page center and then finely toward the document side, thereby reducing the influence on the document data except the gutter side.

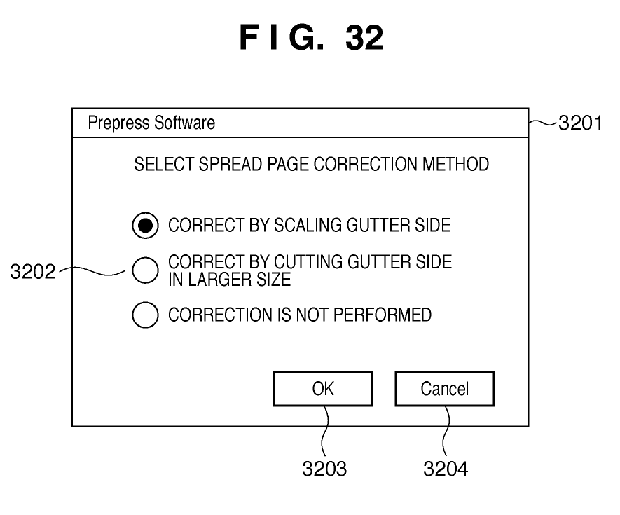

Note that only one of the processes in FIGS. 28 and 30 is applied. The process to apply can be determined either automatically based on, for example, the settings of the print application or in accordance with an instruction input by the operator. For example, the print application may display a message dialogue as shown in FIG. 32 so that the process to apply switches in accordance with a user instruction. Reference numeral 3201 represents an overview of the message dialogue; 3202, a radio button to select a correction process to apply; 3203, an OK button to determine the correction process selected by the radio button 3202; and 3204, a cancel button to cancel the correction method designation.

The operator selects one of the processes in FIGS. 28 and 30 by the radio button 3202, and then presses the OK button 3203 to switch the correction method to apply. Instead of using this method, the print application may always internally execute one of the correction processes. Alternatively, the correction process to apply may be switched based on a threshold such as a binding margin width of xx or more.

The page layout correction processing (page division) has been described using flat stitching as an example. Even for other bookbinding methods, correction processing can be done similarly in consideration of the value of the binding margin and the like.

<Details of Page Layout Correction Processing (Without Page Division) (Step S1708)>

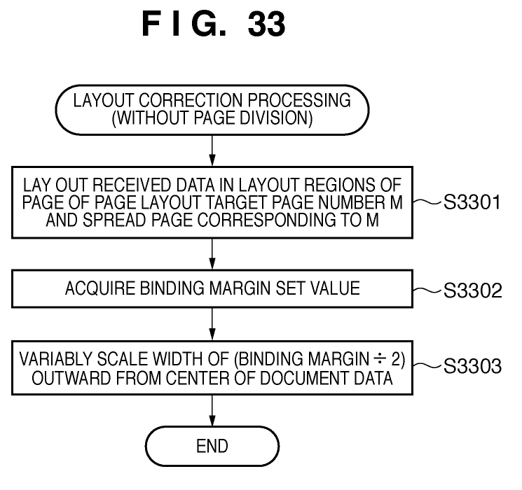

FIG. 33 is a flowchart of page layout correction processing (without page division).

In step S3301, the bookbinding application 104 lays out received document data in the layout region of a spread page corresponding to the page layout target page number M. That is, the document data is laid out, without being divided, on a spread page that allows layout of spread document data without page division.

In step S3302, the bookbinding application 104 acquires a binding margin width from the information of the designated bookbinding method.

In step S3303, the bookbinding application 104 variably scales the portion having the width of (binding margin÷2) from the gutter side.

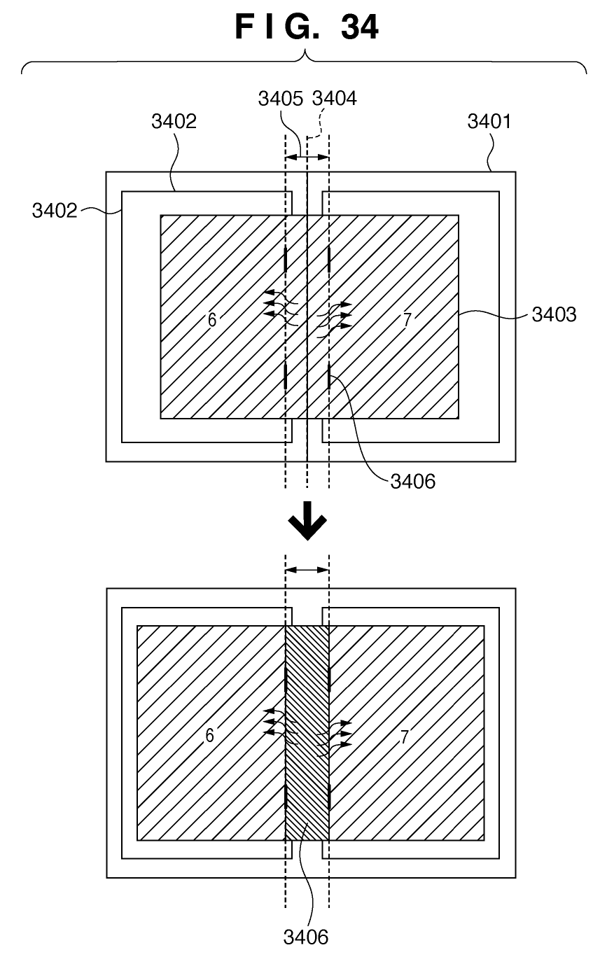

FIG. 34 is a view showing the concept of page layout correction processing (without page division). FIG. 34 illustrates flat stitching as an example. Reference numeral 3401 denotes a sheet; 3402, a page layout region; 3403, document data that has undergone page layout; 3404, a center line (not printed in actuality); 3405, a binding margin width; and 3406, a staple. The binding margin width 3405 indicates the gutter of a finished book, where the document may be invisible due to the influence of binding. When the document data is laid out without division, the document overlaps the binding margin. Hence, correction is necessary. When the portion having the width of (binding margin÷2) from the gutter side is variably scaled outward from the center (i.e., based on the current page number under processing), correction can be done so the document data does not overlap the binding margin. Variable scaling is done here, that is, the process width (process amount) is variable in consideration of the property that the visibility lowers toward the page center in a finished book. Enlargement is performed coarsely at the page center and then finely outward, thereby reducing the influence on the document data except the gutter side.

The page layout correction processing (without page division) has been described using flat stitching as an example. Even for other bookbinding methods, correction processing can be done similarly in consideration of the value of the binding margin and the like.

<Details of Gutter-Side Correction Processing (Step S1710)>

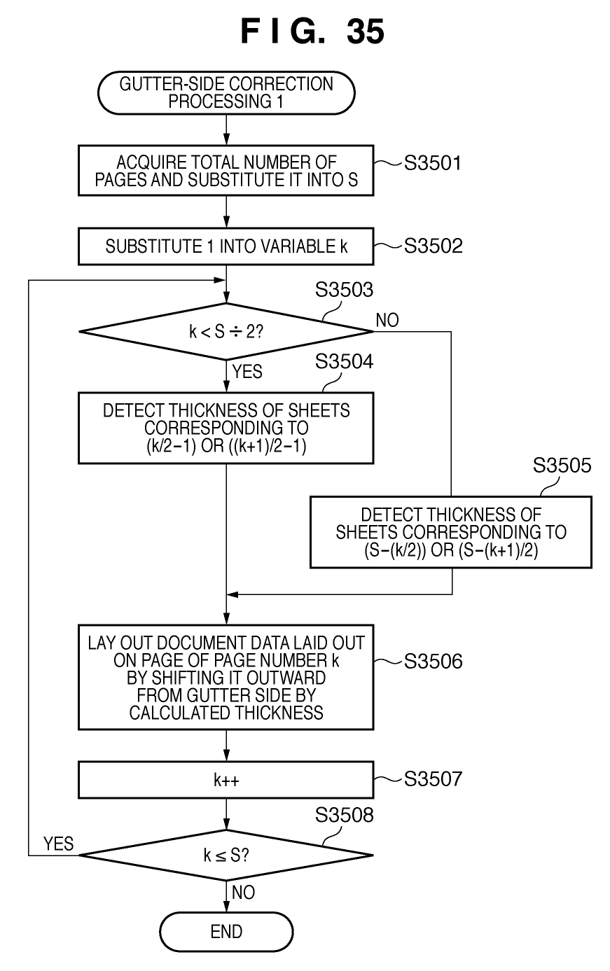

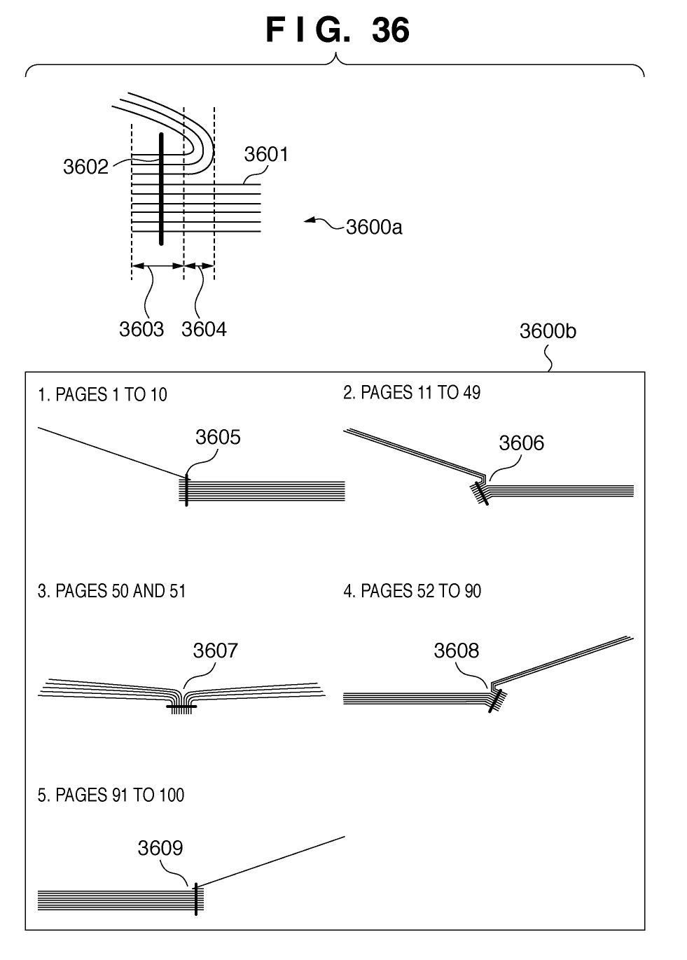

FIG. 35 is a flowchart of gutter-side correction processing (1). Reference numeral 3600a in FIG. 36 represents a conceptual illustration of the gutter of a flat-stitched book viewed from a side so as to explain the gutter property.

Reference numeral 3601 denotes a sheet; 3602, a staple; 3603, a binding margin having a fixed width where the document may be invisible due to the influence of binding; and 3604, a width where the document is hidden because of the thickness of sheets upon turning the leaves. The width 3604 dynamically changes in accordance with the number of turned leaves.

Reference numeral 3600b represents a conceptual illustration of an entire book which is flat-stitched, left-open, and 100 pages long and viewed from a side. States specific to the numbers of turned leaves are illustrated. More specifically, 3600b illustrates book states of five patterns, that is, pages 1 to 10 (3605), pages 11 to 49 (3606), pages 50 and 51 (3607), pages 52 to 90 (3608), and pages 91 to 100 (3609). When turned leaves have page numbers smaller than the total number of pages as indicated by 3605 and 3606, the width 3604 in the illustration 3600a tends to increase in accordance with the number of turned leaves. However, from the half (middle) of the total number of pages indicated by 3607, the width 3604 in the illustration 3600a tends to decrease in accordance with the number of turned leaves. In the states 3608 and 3609, the width 3604 in the illustration 3600a changes in accordance with the number of unturned (remaining) leaves. The gutter-side correction processing considers the gutter property upon turning the leaves of the book.

In step S3501, the bookbinding application 104 acquires the total number of pages of the book and substitutes it into a constant S.

In step S3502, the bookbinding application 104 substitutes 1 into a variable k.

In step S3503, the bookbinding application 104 determines whether the variable k is smaller than ½ of the total number of pages. If the variable k is smaller than ½ of the total number of pages, the process advances to step S3504. If the variable k is equal to or larger than ½ of the total number of pages, the process advances to step S3505.

In step S3504, the bookbinding application 104 calculates a thickness to shift document data of the page number k. First, the position of the page number k in the sequence of turned sheets is calculated. Since pages are assigned to the observe and reverse sides of a sheet, the position of the page number k in the sequence of turned sheets can be known by k/2. If k/2 yields a remainder, a result of (k+1)/2 is used. The number of leaves turned before the page number k can be calculated by subtracting 1 from k/2. The thickness of sheets is calculated based on the calculated number of sheets.

In step S3505, the bookbinding application 104 calculates a thickness to shift document data of the page number k, as in step S3504. In this case, however, since the page number k is equal to or larger than ½ of the total number of pages, the thickness to shift corresponds to the thickness of unturned, remaining sheets. This is a value obtained by subtracting k/2 from the total number of pages. The thickness of sheets is calculated based on the calculated number of sheets.

In step S3506, the bookbinding application 104 shifts the position of the document data laid out on the page with the page number k to the gutter side by the thickness calculated in step S3504 or S3505.

In step S3507, the bookbinding application 104 increments the variable k.

In step S3508, the bookbinding application 104 determines whether the correction processing has ended for all pages. If not all pages have been processed yet, the process returns to step S3503 to repeat the processing. If all pages have been processed, the processing ends.

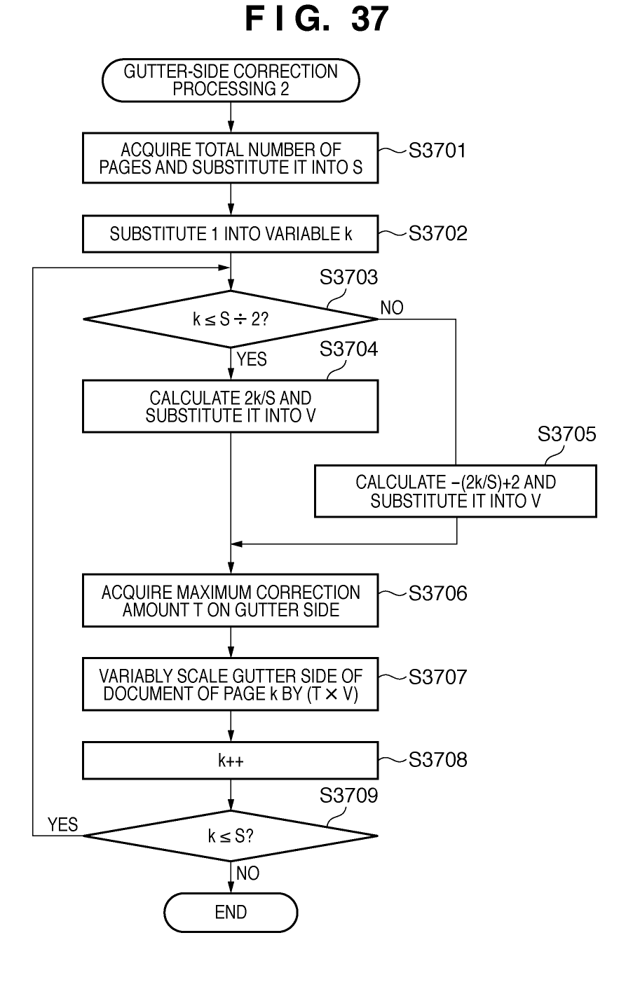

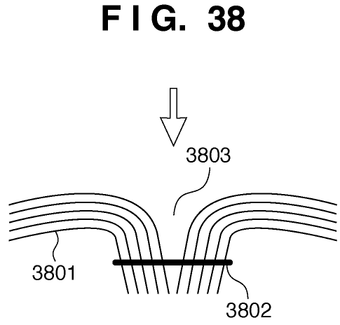

FIG. 37 is a flowchart of gutter-side correction processing (2). FIG. 38 is a conceptual view showing the gutter of a flat-stitched book viewed from a side so as to explain the gutter property.

Reference numeral 3801 denotes a sheet; and 3802, a staple. A gutter side 3803 easily opens at a position closer to the middle of the total number of pages.

In step S3701, the bookbinding application 104 acquires the total number of pages of the book and substitutes it into the constant S.

In step S3702, the bookbinding application 104 substitutes 1 into the variable k.

In step S3703, the bookbinding application 104 determines whether the variable k is equal to or smaller than ½ of the total number of pages. If the variable k is equal to or smaller than ½ of the total number of pages, the process advances to step S3704. If the variable k is larger than ½ of the total number of pages, the process advances to step S3705.

In step S3704, the bookbinding application 104 calculates the position of the page number k in the sequence of all pages. For example, the value is calculated by setting 1 (maximum) at the middle of the total number of pages, and 0 (minimum) at the first and last pages of the total number of pages. If the page number k is equal to or smaller than ½ of the total number of pages, the value can be calculated by 2k/S. The calculated value is stored in a variable V.

In step S3705, the bookbinding application 104 calculates the position of the page number k, as in step S3704. If the page number k is larger than ½ of the total number of pages, the value can be calculated by “−(2k/S)+2”.

In step S3706, the bookbinding application 104 acquires a maximum correction amount T on the gutter side. The maximum correction amount on the gutter side can be either a value predetermined by the print application or a value automatically calculated from the binding margin. A value designated by the operator may be used.

In step S3707, the bookbinding application 104 variably scales the gutter-side portion of the document data inward by the product of the variable V obtained in step S3704 or S3705 and the maximum correction amount T on the gutter side acquired in step S3706. At the middle of the total number of pages, V=1. Hence, the scaling width is maximized. Since the gutter opening becomes noticeable at a position closer to the middle of the total number of pages, as described above, correction is performed in consideration of it.

In step S3708, the bookbinding application 104 increments the variable k.

In step S3709, the bookbinding application 104 determines whether the correction processing has ended for all pages. If not all pages have been processed yet, the process returns to step S3703 to repeat the processing. If all pages have been processed, the processing ends.

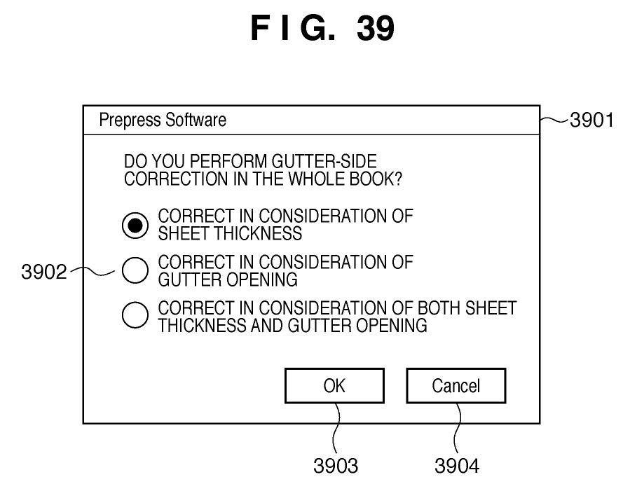

One or both of the above-described gutter-side correction processes (1) and (2) are applied. The correction process to apply can be determined either automatically based on, for example, the settings of the print application or in accordance with an instruction input by the operator. For example, the print application may display a message dialogue as shown in FIG. 39 so that the process to apply switches in accordance with a user instruction. Reference numeral 3901 represents an overview of the message dialogue; 3902, a radio button to select a correction process to apply; 3903, an OK button to determine the correction process selected by the radio button 3902; and 3904, a cancel button to cancel the correction method designation.

The operator selects one or both of the above-described gutter-side correction processes (1) and (2) by the radio button 3902, and then presses the OK button 3903 to switch the correction method to apply. Instead of using this method, the print application may always internally execute one of the correction processes. Alternatively, the correction process to apply may be switched based on a threshold such as a binding margin width of xx or more.

The gutter-side correction processing has been described using flat stitching as an example. Even for other bookbinding methods, correction processing can be done similarly in consideration of the gutter property, the value of the binding margin, and the like.

As described above, according to the document processing system of the first embodiment, it is possible to easily perform page layout suitable for a bookbinding method. It is also possible to easily perform spread document data gutter correction processing suitable for a bookbinding method. For these reasons, even an operator other than specialists can appropriately easily perform page layout and gutter correction processing.

(Modification)

The document processing system can be either the standalone type system of the first embodiment or a server-client system. For example, a server may collectively manage book files and print processing.

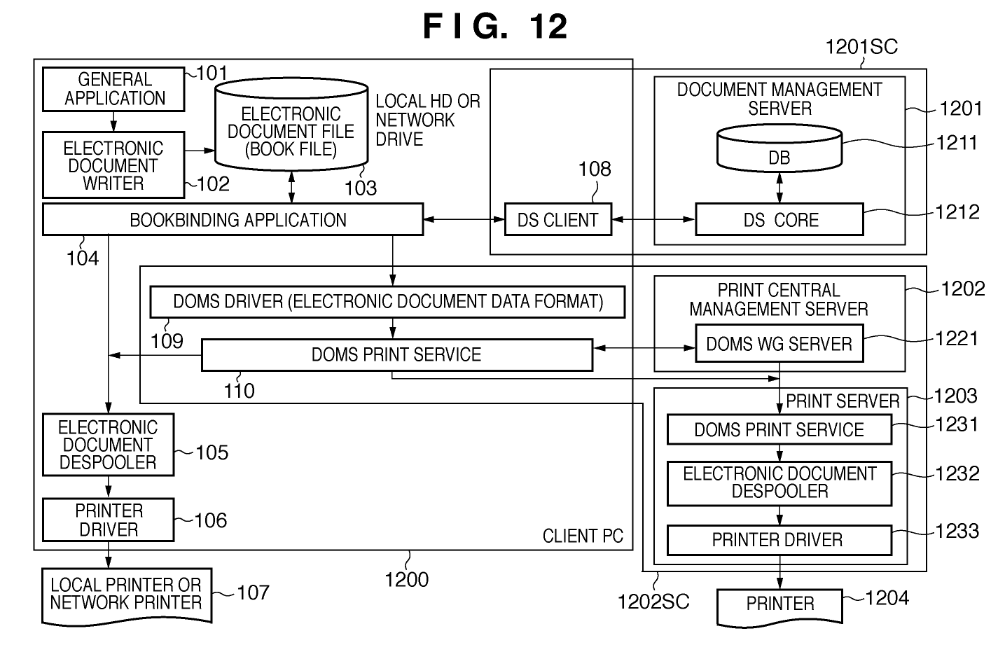

FIG. 12 is a block diagram showing the arrangement of a server-client type document processing system. The server-client type document processing system is formed by adding a DOMS driver 109, DOMS print service module 110, and DS client module 108. “DOMS” is short for a document output management service. “DS” is short for a document service.

A document management server 1201, print central management server 1202, and print server 1203 are connected to a document processing system 1200.

In the example shown in FIG. 12, both the document management server 1201 and the print central management server 1202 are connected to the client. However, only one of them may exist on the network. For example, if the document management server is connected as a server, a document management server-client system 1201SC including the client module 108 is added. For the print central management server 1202, a print management server-client system 1202SC including the client module is added.

The document management server 1201 stores book files created and edited by the bookbinding application 104. The book files are stored in a database 1211 of the document management server 1201. Book file storage and readout between the bookbinding application 104 and the document management server 1201 are done via the DS client module 108 and a DS core 1212.

The print central management server 1202 manages printing of the book files. A print request from the client is transmitted to a DOMS WG server module 1221 in the print central management server 1202 via the DOMS driver 109 and the DOMS print service module 110. The print central management server 1202 transfers electronic document data to the electronic document despooler 105 via the DOMS print service module 110. When the print server 1203 is to perform printing, the print central management server 1202 transmits electronic document data to a DOMS print service module 1231 of the print server 1203.

### Other Embodiments

The embodiment of the present invention has been described above in detail. The present invention is applicable to a system including a plurality of devices, or an apparatus including a single device.

The present invention is also achieved by supplying a program to implement the functions of the above-described embodiment to the system or apparatus directly or from a remote site and causing the system or apparatus to read out and execute the supplied program code. Hence, the program code (computer program) itself, which is installed in a computer to cause it to implement the functional processing of the present invention, is also incorporated in the technical scope of the present invention.

In this case, the program can take any form such as an object code, a program to be executed by an interpreter, or script data to be supplied to the OS as long as the functions of the program can be obtained.

Examples of the recording medium to supply the program are a floppy® disk, hard disk, optical disk (CD or DVD), magnetooptical disk, magnetic tape, nonvolatile memory card, and ROM.

The functions of the above-described embodiment are implemented when the computer executes the readout program. The functions of the above-described embodiment can also be implemented by causing the OS running on the computer to partially or wholly execute actual processing based on the instructions of the program.

Alternatively, the program read out from the recording medium is written in the memory of a function expansion board inserted into the computer or a function expansion unit connected to the computer. Then, the CPU of the function expansion board or function expansion unit partially or wholly executes actual processing based on the instructions of the program, thereby implementing the functions of the above-described embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-137228, filed May 26, 2008, which is hereby incorporated by reference herein in its entirety.

What is claimed is:

1. An image processing apparatus comprising:
a determination unit which, when booklet printing of forming a book by folding a plurality of sheets is set, determines, based on a shape of image data to be laid out on the sheet, whether to lay out the image data on a spread of the book;
a decision unit which decides, based on an object in the image data determined to be laid out on the spread of the book, whether to divide and lay out the image data; and
a layout unit which divides the image data decided by said decision unit to be divided, and lays out each of the divided image data on the sheet of the spread.

2. The apparatus according to claim 1, wherein said decision unit comprises a division determination unit which determines, when dividing the image data, whether at least one object included in the image data is to be divided into a plurality of pages.

3. The apparatus according to claim 2, wherein said decision unit further comprises:
a notification unit which notifies a user of a determination result of said division determination unit; and
an accepting unit which accepts, from the user, an instruction to divide the image data or not.

4. The apparatus according to claim 1, wherein said decision unit decides not to perform page division of the image data when the image data to be laid out on the spread of the book is laid out on two adjacent pages on the same surface of a single sheet.

5. The apparatus according to claim 1, wherein the booklet printing includes saddle stitching, flat stitching, and case binding.

6. The apparatus according to claim 1, further comprising an image modification unit which performs, for each image data to be laid out by said layout unit, scaling processing of an image to be laid out on a binding side upon completing bookbinding.

7. The apparatus according to claim 6, wherein said image modification unit changes a process amount of the scaling processing based on the total number of pages and a page number of image data under processing.

8. The apparatus according to claim 1, wherein the shape is identified based on vertical and horizontal lengths of the image data.

9. A method of controlling an image processing apparatus, comprising the steps of:
when booklet printing of forming a book by folding a plurality of sheets is set, determining, based on a shape of image data to be laid out on the sheet, whether to lay out the image data on a spread of the book;
deciding, based on an object in the image data determined to be laid out on the spread of the book, whether to divide and lay out the image data; and
dividing the image data decided in the deciding step to be divided, and laying out each of the divided image data on the sheet of the spread.

10. A computer-readable recording medium storing a computer program which causes a computer to execute the steps of:
when booklet printing of forming a book by folding a plurality of sheets is set, determining, based on a shape of image data to be laid out on the sheet, whether to lay out the image data on a spread of the book;
deciding, based on an object in the image data determined to be laid out on the spread of the book, whether to divide and lay out the image data; and
dividing the image data decided in the deciding step to be divided, and laying out each of the divided image data on the sheet of the spread.
